(19) United States
(12) Patent Application Publication
(10) Pub. No.: US 2013/0158445 A1
(43) Pub. Date: Jun. 20, 2013

(54) ORTHESIS SYSTEM AND METHODS FOR CONTROL OF EXOSKELETONS

(71) Applicants: Homayoon Kazerooni, Berkeley, CA (US); Wayne Yi Tung, Berkeley, CA (US); Jason Ira Reid, Berkeley, CA (US); Michael Geoffrey Mckinley, Berkeley, CA (US)

(72) Inventors: Homayoon Kazerooni, Berkeley, CA (US); Wayne Yi Tung, Berkeley, CA (US); Jason Ira Reid, Berkeley, CA (US); Michael Geoffrey Mckinley, Berkeley, CA (US)

(73) Assignee: THE REGENTS OF THE UNIVERSITY OF CALIFORNIA, Oakland, CA (US)

(21) Appl. No.: 13/818,338

(22) PCT Filed: Aug. 23, 2011
(86) PCT No.: PCT/US11/48761

§ 371 Date: Feb. 22, 2013

Related U.S. Application Data
(60) Provisional application No. 61/376,086, filed on Aug. 23, 2010.
(60) Provisional application No. 61/385,610, filed on Sep. 23, 2010.

(51) Int. Cl. A61H 3/00

(52) U.S. Cl. CPC A61H 3/00
USPC 601/35

(57) ABSTRACT

An orthesis system includes an exoskeleton configured to be coupled to a user and a separate support device in the form of crutches, a walker or a cane. Preferably, the exoskeleton includes leg supports, an exoskeleton trunk, and actuators to provide for movement of the exoskeleton. The support device includes at least one support handle and a signal generator coupled to the support handle configured to generate and send a user command signal to an exoskeleton controller when activated by the user. The user command signal causes the exoskeleton controller to shift the exoskeleton between a first operational state and a second operational state. Optionally, a signal generator separate from the support device may be utilized to control the exoskeleton. Operational states of the exoskeleton include Walking, Standing, Seated, Sitting, Down and Standing Up states. User command signals can include a combination of distinct main, walking, or stopping signals.

### CROSS-REFERENCE TO RELATED APPLICATIONS

The present invention claims the benefit of U.S. Provisional Patent Application Ser. No. 61/376,086 entitled “Devices and Methods for Control of Exoskeletons” filed on Aug. 23, 2010 and U.S. Provisional Patent Application Ser. No. 61/385,610 entitled “A Method of Controlling an Exoskeleton” filed on Sep. 23, 2010.

### STATEMENT REGARDING FEDERALLY SPONSERED RESEARCH OR DEVELOPMENT

This invention was made with government support under Contract No. 005400 awarded by the National Science Foundation. The government has certain rights in the invention.

### BACKGROUND OF THE INVENTION

1. Field of the Invention

The present invention pertains to the art of orthesis systems including exoskeletons to be used by people with mobility disorders.

2. Discussion of the Prior Art

Patients who have difficulty walking often use wheelchairs for mobility. It is a common and well-respected opinion in the field that postponing the use of wheelchairs will retard the onset of other types of secondary disabilities and diseases. The ramifications of long-term wheelchair use are secondary injuries to the body including hip, knee, and ankle contractures, heterotopic ossification of lower extremity joints, frequent urinary tract infection, spasticity, and reduced heart and circulatory function. These injuries must be treated with hospital care, medications, and several surgical procedures. In a 25-30 year treatment program, the average cost of treatment to one paraplegic patient is approximately $750,000, a heavy burden on both the patient and healthcare resources. Physicians strongly advocate the idea that it is essential for patients to forgo the use of wheelchairs and remain upright and mobile as much as possible.

Functional Electrical Stimulation (FES) is primarily used to restore function in people with disabilities. FES is a technique that uses electrical currents to activate muscles in lower extremities affected by paralysis resulting from spinal cord injury (SCI), head injury, stroke and other neurological disorders. The patient wears a set of orthoses for stability. An electrical stimulator is always in the “off” mode except when the patient decides to walk. By triggering a mini-switch mounted on each handlebar of a rolling walker, the patient activates one or some of the quadriceps and hamstrings and muscles. The trigger signal from the switch is transmitted to the stimulator via a cable from the walker. The pulsed current is applied to the patient via conventional carbon-impregnated rubber electrodes covered with solid gel. The book titled “Functional Electrical Stimulation: Standing and Walking After Spinal Cord Injury”, Alojz R. Kralj, Tadej Bajd, CRC Press 1989, describes various technologies associated with FES. Another informative reference is “Current Status of Walking Orthoses for Thoracic Paraplegics”, published in The Iowa Orthopaedic Journal by D'Ambrosia.

“Voluntary commands for FES-assisted walking in incomplete SCI subjects”, published in Journal Medical & Biological Engineering & Computing, May 1995 describes cases where the control of the stimulator is realized by the help of two transducers; a crutch hand switch and a crutch tip switch. “Development of a walking assist machine using crutches (Composition and basic experiments)”, by Higuchi et., al., published in the Journal of Mechanical Science and Technology 24 (2010) 245˜248 describes the use of a pressure sensor on a crutch grip to detect the intention to start walking for each walking cycle of a walking assist device.

Another method of ambulation is to use powered exoskeleton systems. In some exoskeletons such as described in U.S. Patent Application Publication No. 2011/0066088, a joystick and keypad are mounted on an arm. The arm may be mounted vertically from the user at about waist height. The joystick and keypad are used to explicitly issue commands and user intent. In some embodiments such as described in U.S. Pat. No. 7,153,242, the motion of an exoskeleton torso is used to command the exoskeleton. Sensors which are used to communicate user intent include ground force sensors located in the feet of the exoskeleton and a tilt sensor which is located on the shoulder strap of the controller pack. The user leans his/her torso forward and the tilt sensor determines that the user is initiating a step. The computer determines which leg to swing by measuring ground forces and swinging the leg that has lower ground forces applied through it.

We believe these smart exoskeleton systems will replace wheelchairs and enable individuals who cannot walk due to neurological disorders, muscular disorders, or aging, to walk again. One purpose of this document is to teach some innovative ways of commanding lower extremity exoskeleton systems, regardless of the exoskeleton architectures and actuation types. In particular, this document shows how one can control the exoskeleton to move from one state to another state.

### SUMMARY OF THE INVENTION

The present invention is directed to an orthesis system including an exoskeleton configured to be coupled to a user and a support device separate from the exoskeleton to be held by a user of the exoskeleton for stabilization. In general, the exoskeleton comprises first and second leg supports configured to be coupled to a user's lower limbs. Each of the first and second leg supports includes a thigh link. An exoskeleton trunk is configured to be coupled to a user's upper body and is rotatably connected to each of the first and second leg supports to allow for the flexion and extension between the first and second leg supports and the exoskeleton trunk. First and second actuators coupled to respective first and second leg supports provide for movement of the exoskeleton. An exoskeleton controller receives user command signals and shifts the exoskeleton between a plurality of operational states, including a Seated State, a Standing State a plurality of Walking States and a Stopping State. In accordance with one method of the present invention, a first main signal generated when the exoskeleton is in a seated state causes the exoskeleton to move from the seated state to the standing state; a walking signal generated when the exoskeleton is in the standing state causes the exoskeleton to move from the standing state to the walking state; a stopping signal generated when the exoskeleton is in a walking state causes the exoskeleton to move from the walking state to the standing state; and a second main signal generated when the exoskeleton is in the standing state causes the exoskeleton to move from the standing state to the seated state. Alternatively, first and second walking signals and first and second stopping signals are utilized to shift the exoskeleton between the operational states discussed above.

In general, the support device, which may be in the form of crutches, a cane, or a walker, includes at least one support handle, and a signal generator coupled to the support handle configured to generate and send a user command signal to the exoskeleton controller when activated by a user of the support device. The user command signal causes the exoskeleton controller to shift the exoskeleton between a first operational state and a second operational state. In use, a person is coupled to the exoskeleton and activates a signal generator with their fingers to send user command signals to the exoskeleton controller. The exoskeleton controller then shifts the exoskeleton between various operational states based on the user command signals received.

### BRIEF DESCRIPTION OF THE DRAWINGS

FIG. 1 is a rear perspective view of a powered exoskeleton orthotic system including crutches;

FIG. 2 is a rear perspective view of a powered exoskeleton orthotic system including a walker;

FIG. 3 is a partial perspective view of a crutch of the present invention with a thumbwheel method of control;

FIG. 4 is a partial perspective view of a walker of the present invention with a thumbwheel method of control;

FIG. 5 is a graph showing thumbwheel rotation and exoskeleton speed as a function of time;

FIG. 6 is a graph showing thumbwheel rotation and exoskeleton speed as a function of time;

FIG. 7 is a graph showing spring-loaded thumbwheel rotation and exoskeleton speed as a function of time;

FIG. 8 is a graph showing a signal from the angle of thumbwheel rotation and exoskeleton speed;

FIG. 9 is a partial perspective view of a sliding command switch of the present invention located on a cane;

FIG. 10 is a graph showing signals generated by a spring-loaded sliding switch and exoskeleton speed as a function of time;

FIG. 11 is a partial view of a rocker switch for commanding exoskeleton speed in accordance with the invention;

FIG. 12 is a graph showing signals from a rocker switch A side and exoskeleton speed as a function of time;

FIG. 13 is a graph showing: Signal from rocker switch B side and exoskeleton speed as a function of time;

FIG. 14 is a partial perspective view of a handle including a sliding switch of the present invention;

FIG. 15 is a partial perspective view of a handle including a rotary switch of the present invention;

FIG. 16 is a graph showing sliding or rotary switch and exoskeleton speed as a function of time;

FIG. 17 is a graph showing duration of input device signal on A side and exoskeleton speed as a function of time;

FIG. 18A depicts a sliding switch in accordance with the present invention;

FIG. 18B depicts the rocker switch in accordance with the present invention;

FIG. 18C depicts a thumbwheel in accordance with the present invention;

FIG. 18D depicts a rotary switch in accordance with the present invention;

FIG. 19 is a partial perspective view of a crutch handle including pushbuttons;

FIG. 20 is a partial perspective view of a crutch handle including a rocker switch;

FIG. 21 is a partial perspective view of a crutch including a computer mouse coupled to a crutch handle for controlling an exoskeleton;

FIG. 22 is a perspective view of a crutch handle having an alternative computer mouse coupled thereto for controlling an exoskeleton;

FIG. 23 is a diagram of various user signals and operational states in accordance with a method of the present invention;

FIG. 24 is a diagram of various user signals and operational states in accordance with a method of the present invention;

FIG. 25 is a partial perspective view of a crutch of the present invention with a thumbwheel and pushbutton method of control;

FIG. 26 is a partial perspective view of a crutch of the present invention including main, walking and stopping signal generating pushbuttons;

FIG. 27 is a partial perspective view of a crutch of the present invention with a thumbwheel and two pushbuttons;

FIG. 28 is a partial perspective view of a crutch of the present invention with a sliding switch and pushbutton method of control;

FIG. 29 is a partial perspective view of a crutch of the present invention with a thumbwheel and pushbutton;

FIG. 30 is a diagram of various user signals and operational states in accordance with a method of the present invention;

FIG. 31 is a partial perspective view of a crutch of the present invention with a two pushbutton method of control;

FIG. 32 is a partial perspective view of a crutch of the present invention with a sliding switch method of control;

FIG. 33 is a partial perspective view of a crutch of the present invention utilizing a two position sliding switch;

FIG. 34 is a diagram of various user signals and operational states in accordance with a method of the present invention;

FIG. 35 is an embodiment of the invention including a brain signal recognition system;

FIG. 36 is a diagram representing some processes in the brain signal recognition system of FIG. 35;

FIG. 37 is an embodiment of the invention including a voice recognition system; and

FIG. 38 is a diagram representing some processes in the voice recognition system of FIG. 37.

### DETAILED DESCRIPTION OF THE PREFERRED EMBODIMENT

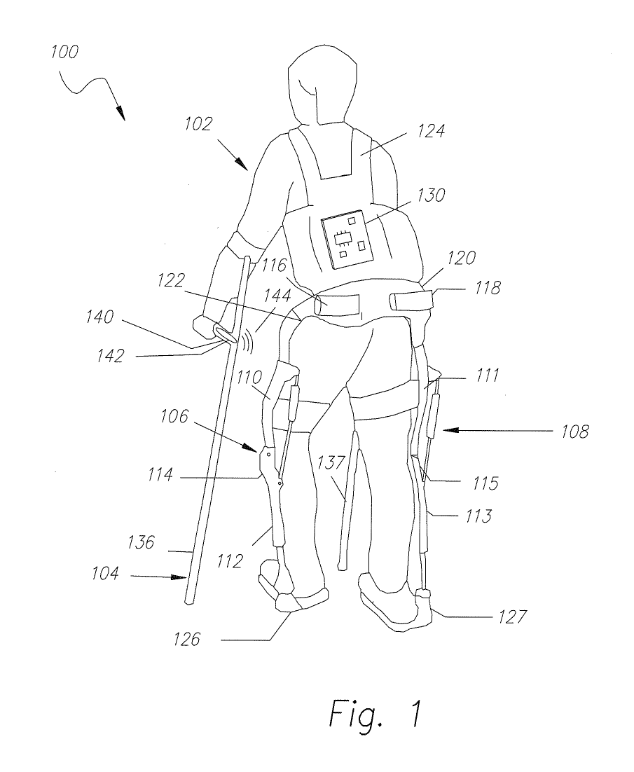

A first embodiment of an orthesis system of the present invention is generally indicated at 100 in FIG. 1. In general, orthesis system 100 includes a powered exoskeleton 102 configured to be coupled to a person, and a separate support device 104 to provide the person with additional stabilization. By “separate” it is meant that exoskeleton 102 and support device 104 are not integrally or permanently connected, such that any number of different types of support devices 104 could be paired with any number of different types of exoskeleton devices, depending on the needs and limitations of a particular user. It should be understood that various different types of powered exoskeletons could be adapted for use with the present invention. Such exoskeletons are powered and allow the wearers to walk upright without any substantial energetic drain. Various mechanical architectures for the exoskeleton systems may have different degrees of freedom and actuations. In some embodiments, the exoskeletons are powered electrically and some are powered hydraulically. U.S. Pat. No. 7,628,766 describes one example of a lower extremity exoskeleton system. Additionally, U.S. Patent Application Publication Nos. 2007/0056592 and 2006/0260620 teach various architectures of lower extremities.

In the embodiment depicted in FIG. 1, exoskeleton 102 is configured for use by paraplegics for locomotion and includes first and second leg supports 106 and 108 configured to be coupled to the person's lower limbs and rest on a support surface during a stance phase. Each of the first and second leg supports includes a thigh link 110, 111 and a shank link 112, 113 interconnected by a knee joint 114, 115. Actuators 116 and 118 are adapted to apply torque to the leg supports 106, 108. An exoskeleton trunk 120 is configured to be coupled to a person's upper body and rotatably connects to respective first and second leg supports 106 and 108 at hip joints indicated at 122. Exoskeleton trunk 120 is preferably in the form of a supportive back frame. The attachment means utilized to connect exoskeleton trunk 120 to the person may be direct, such as strapping the user directly to the back frame via straps 124, or indirect, such as through a detachable harness (not shown) worn by the user which engages the back frame. Additionally, two foot links 126 and 127 are connected to the distal ends of the leg supports 106 and 108. Exoskeleton 102 further includes a controller 130 which communicates with actuators 116 and 118 to shift exoskeleton 102 between various operational states, such as a Standing State, a Walking State and a Seated State. It should be readily understood that in a Standing State exoskeleton 102 and the user are in a standing position, in a Walking State exoskeleton 102 and the user are walking and in a Seated State exoskeleton 102 and the user are seated. Exoskeleton 102 can include various other elements such as multiple articulating joints that allow the movement of a user's lower extremities to be closely followed, additional actuators and sensors. However, unlike known powered exoskeleton devices, exoskeleton 102 includes a controller 130 that is configured to receive and respond to signals generated by separate support device 104.

In the first embodiment, support device 104 is in the form of a set of first and second crutches 136, 137, wherein each of the first and second crutches 136 and 137 includes a handle indicated at 140. Although a set of crutches 136, 137 is depicted, it should be understood that a user could utilize only one crutch at a time. In accordance with the present invention, a signal generator 142 incorporated into each of handles 140 is configured to generate and send a user command signal generally indicated at 144 to exoskeleton controller 130. In response to user command signal 144, controller 130 causes exoskeleton 102 to shift between various operational states, as will be discussed in more detail below. User command signals 144 can be sent wirelessly, as depicted in FIG. 1, or via a wired connection (not depicted).

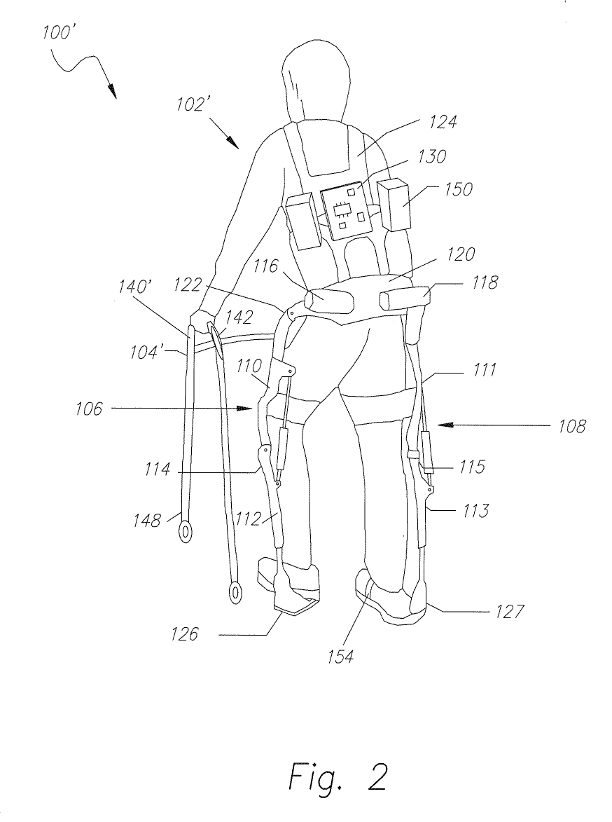

FIG. 2 depicts a second embodiment of orthosis system 100′, including an exoskeleton device 102′ similar to the one depicted in FIG. 1, and a support device 104′ in the form of a walker 148. Exoskeleton 102′ further includes a portable power supply 150 and foot attachments shown at 154 for further coupling a user's feet to exoskeleton 102′. Similar to crutches 136, 137, walker 148 includes opposing handles indicated at 140′, each including a signal generator 142 for generating and sending a user command signal 144 to exoskeleton controller 130.

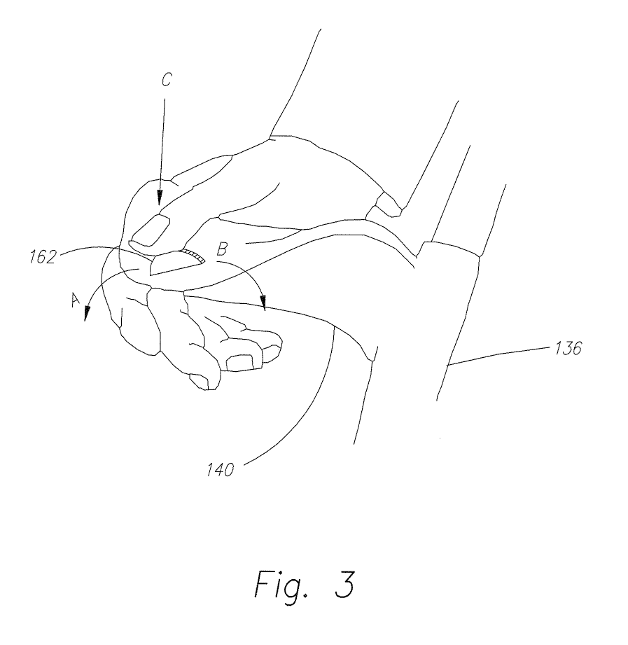

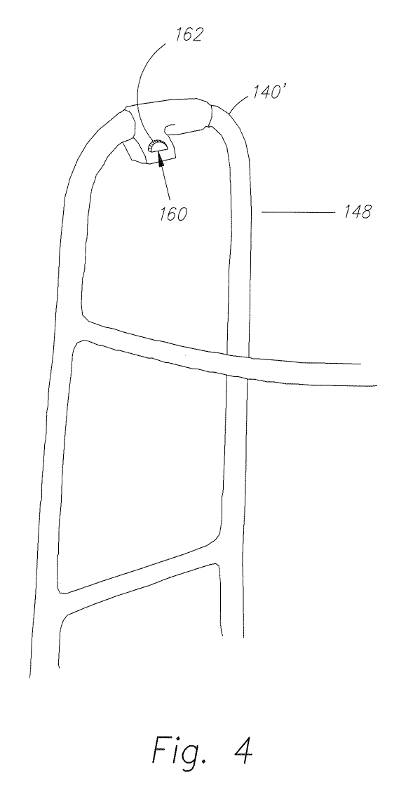

Turning to FIG. 3 of the application, a user control 160 of signal generator 142 is shown in the form of a thumbwheel 162. In the embodiment shown, thumbwheel 162 is integrated into handle 140 of crutch 136. In an alternative embodiment depicted in FIG. 4, thumbwheel 162 is incorporated into handle 140′ of a walker 148. Regardless of the type of support device 104, thumbwheel 162 is utilized by a user to command exoskeleton 102 to shift the exoskeleton between operational states. More specifically, a user will use his or her fingers to turn thumbwheel 162, thereby controlling exoskeleton 102. In some embodiments of the invention, if thumbwheel 162 is rotated along a forward direction A once (e.g., stroked once along the forward direction), then exoskeleton 102 moves forward with a particular speed. If the user turns thumbwheel 162 once more (e.g., strokes once more), then exoskeleton 102 moves a little faster. One can program exoskeleton controller 130 such that every time the user strokes thumbwheel 162, a small amount of velocity is added to the exoskeleton motion. When the user turns thumbwheel 162 (i.e., strokes the thumbwheel) in the opposite direction B, then the exoskeleton's speed will be reduced. In summary, in this embodiment, every stroke on thumbwheel 162 will increase or reduce the exoskeleton speed.

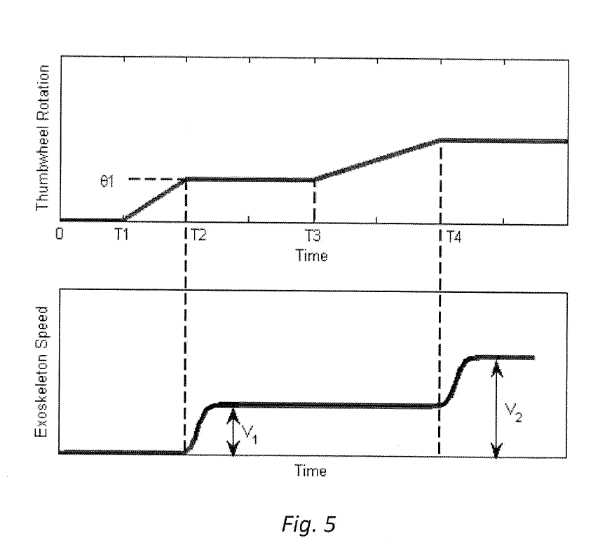

FIG. 5 shows the plots of the thumbwheel rotation and the exoskeleton speed as a function of time. At time T₁, the user starts to turn thumbwheel 162 once (shown by θ₁). T₂ shows the time that the stroke by the operator ends. The time between T₁ and T₂ depends on how fast or slow the operator turns thumbwheel 162. Once this rotation is done by the user, the exoskeleton speed increases from zero to a finite value V₁ (i.e., exoskeleton starts to move). At time T₃, the user turns thumbwheel 162 once more. T₄ shows the time where the rotation of thumbwheel 162 is complete. It can be seen that this time, the user has turned thumbwheel 162 slower than the previous time since the time duration between T₄ and T₃ is larger than the time duration between T₂ and T₁. As can be seen from FIG. 5, the exoskeleton velocity increases to V₂ after the user's second strike on thumbwheel 162.

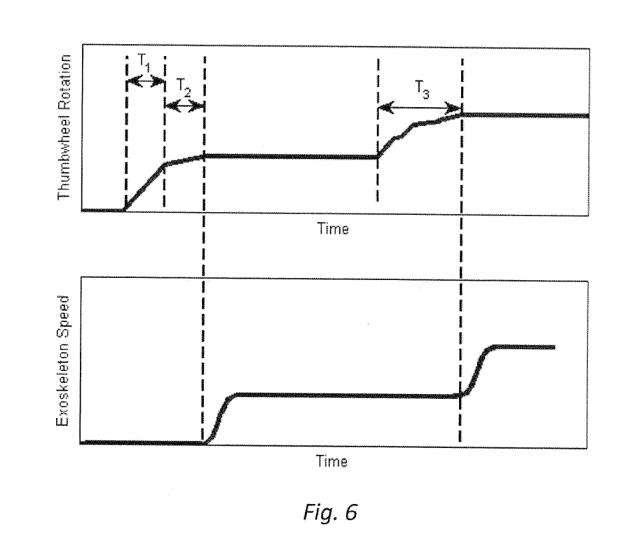

In general, thumbwheel 162 sends its rotation angle to exoskeleton controller 130. Depending on the user, this rotation angle can have many shapes as a function of time. FIG. 6 shows the rotation of thumbwheel 162 as a function of time for several examples. Initially, FIG. 6 shows the situation where thumbwheel 162 is turned first fast (during T₁ period) and then slowly (during T₂ period). FIG. 6 also shows when thumbwheel 162 is turned rather irregularly during the T₃ period. The approach in commanding the exoskeleton speed that is described above with reference to FIG. 5 is immune to the shape of how the user has turned thumbwheel 162, since it only relies on whether thumbwheel 162 has turned or not. Once thumbwheel 162 is turned, the exoskeleton speed is either increased or decreased depending on the stroke direction. In some embodiments, the magnitude of the exoskeleton speed increase or speed decrease is either constant (i.e., pre-programmed to be a constant magnitude) or a function of various variables such as the ground slope or the user's weight and ability. The key issue described by the embodiments of FIGS. 5 and 6 is that the incremental decrease or increase in speed is resulted when a stroke has taken place on thumbwheel 162.

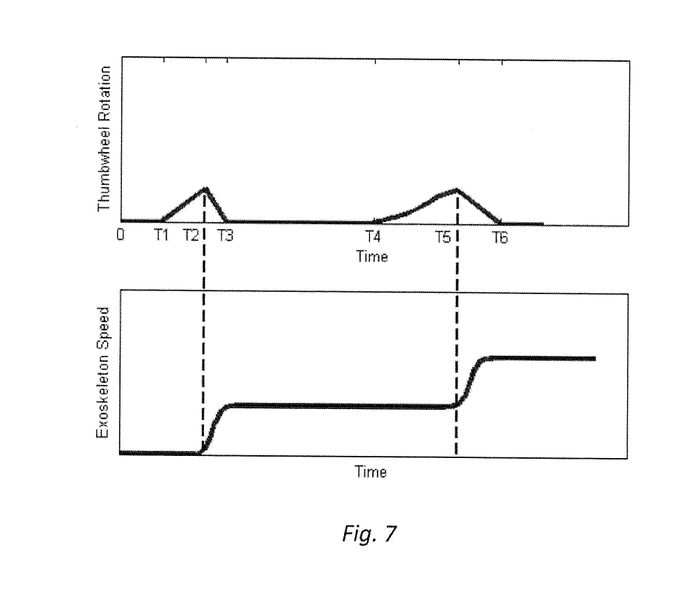

In some embodiments of the invention, thumbwheel 162 is spring-loaded and once it is rotated forwardly or backwardly and released, it will automatically come back to its center or starting location. FIG. 7 shows the angle of a spring-loaded thumbwheel 162. The user initiates to turn thumbwheel 162 at time T₁. At time T₂, the user releases thumbwheel 162 and thumbwheel 162 comes back to its center location at time T₃. As can be seen from FIG. 7, exoskeleton 102 increases its velocity after thumbwheel 162 is released. The operator initiates another stroke on thumbwheel 162 at time T₄. At time T₅, the users releases thumbwheel 162 and thumbwheel 162 comes back to its center location at time T₆. Exoskeleton 102 increases its velocity after thumbwheel 162 is released. In general, one can anticipate that a variety of forms of data can be generated by use of a thumbwheel or a spring-loaded thumbwheel 162. The key issue we are addressing here is that one can arrive at various mappings between the data generated by thumbwheel 162 and what exoskeleton 102 should do. In other words, once controller 130 receives a user command signal 144 from thumbwheel 162, exoskeleton controller 130 brings exoskeleton 102 from one state to another state. In the examples described in the embodiments of FIGS. 5, 6 and 7, exoskeleton 102 will have an incremental speed increase once thumbwheel 162 is rotated forward. In the examples above, the thumbwheel rotation speed (either forward or backward) did not assign the exoskeleton speed; the fact that thumbwheel 162 was rotated once in the forward direction or backward direction increased or decreased the exoskeleton speed. This means that the mapping between the thumbwheel motion and the exoskeleton motion was in fact between the frequency of thumbwheel rotation (stroke by the user) and the speed of exoskeleton 102. In other words, in the above examples, it did not matter how fast or slow thumbwheel 162 was rotated; as long as it is rotated once, a small incremental velocity is added to the exoskeleton speed. This is also true when a spring-loaded thumbwheel 162 is used to drive exoskeleton 102. Once spring-loaded thumbwheel 162 is rotated forward and released, exoskeleton controller 130 knows that the exoskeleton speed must be incremented by a small amount. If the user then rotates spring-loaded thumbwheel 162 backward and releases it, the exoskeleton speed is decreased.

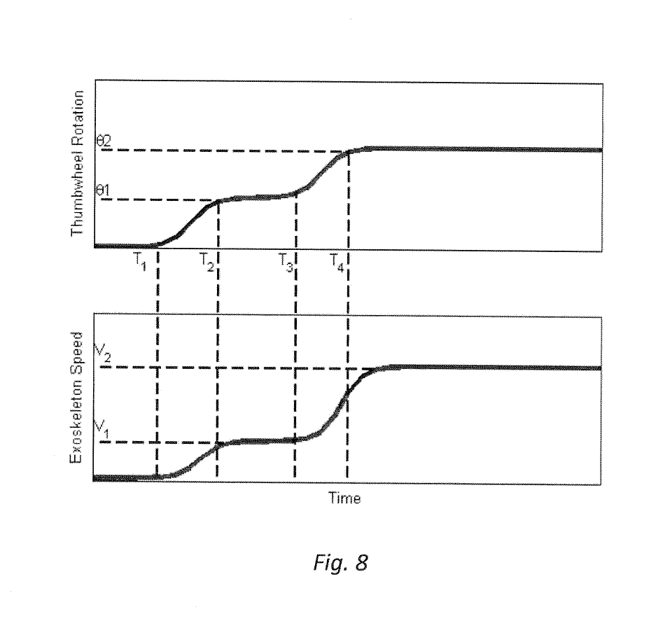

In some embodiments of the invention where a thumbwheel is used to command the exoskeleton speed, the exoskeleton speed is assigned by the actual angle thumbwheel 162 has been rotated. FIG. 8 shows an example of this embodiment. The time between T₁ and T₂ shows when thumbwheel 162 is rotated as much as θ₁. FIG. 8 also shows the exoskeleton speed increases from zero to some finite value of V₁. Thumbwheel 162 is rotated in between time T₃ and T₄ again. As can be seen, this increase of the thumbwheel rotation commands an increase in the exoskeleton speed to V₂. The delay observed in the exoskeleton speed in FIG. 8 shows the natural delay between the commanded value and the actual exoskeleton speed. In summary, the exoskeleton speed becomes proportional to the thumbwheel rotation in this embodiment. Although this proportionality between the thumbwheel rotation and the exoskeleton speed is rather practical and simple, one can arrive at a variety of functionality between the thumbwheel rotation and the exoskeleton speed. In other words, one can develop an algorithm such that the exoskeleton speed becomes a function of how much the thumbwheel has rotated. This means V=f(θ) where V is the exoskeleton speed and θ a thumbwheel angular rotation. One should notice that this approach can be implemented on all kinds of thumbwheels, regardless if they are spring-loaded or not.

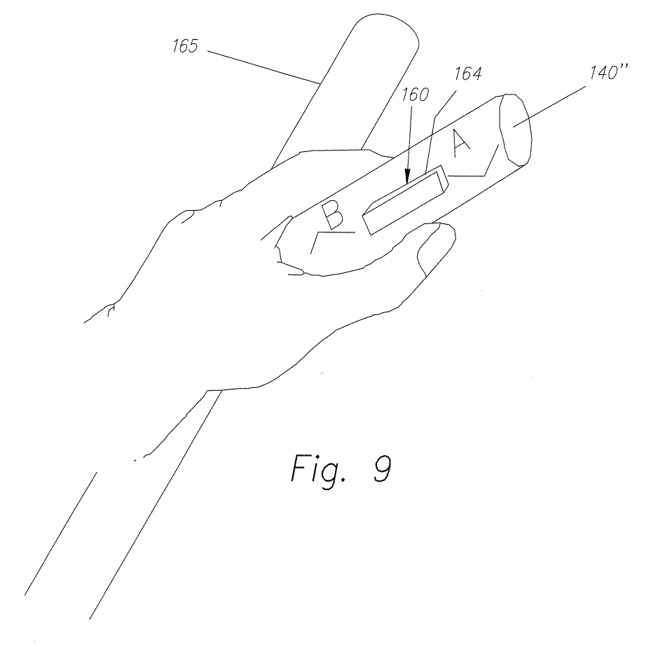

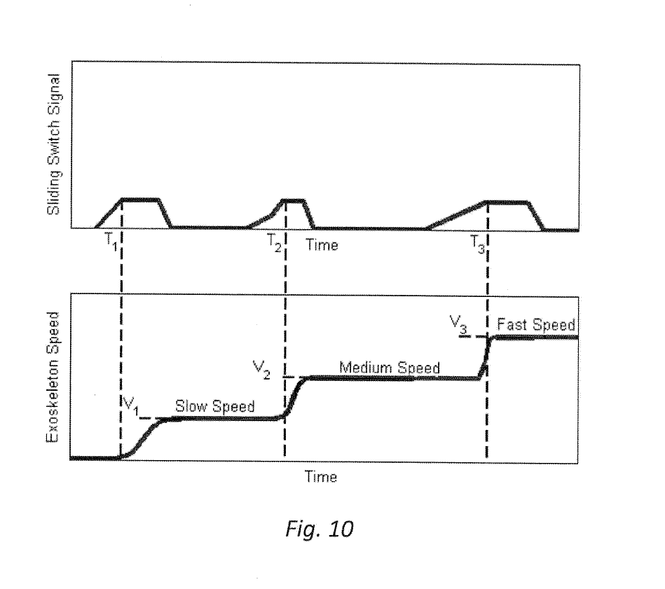

In another embodiment of the present invention, user control 160 is in the form of a spring-loaded sliding switch 164, as depicted in FIG. 9. In the embodiment shown, sliding switch 164 is incorporated into a handle 140″ of a cane 165. Once spring-loaded sliding switch 164 is pushed along the A or B direction by the user and released, it comes back to the center or neutral position. In operation, when the user pushes sliding switch 164 to the A position, exoskeleton controller 130 adds an incremental value to the exoskeleton speed. When sliding switch 164 is pushed to the B direction, exoskeleton controller 130 reduces the exoskeleton speed by a predefined value. The operator controls the exoskeleton speed (i.e., increases or decreases the exoskeleton speed) by moving sliding switch 164 toward the A direction or B direction. In one example, exoskeleton controller 130 has assigned three speed values for exoskeleton 102. With the first strike of sliding switch 164 toward the A direction, exoskeleton 102 starts to move with slow speed. FIG. 10 shows the signal that is generated by spring-loaded sliding switch 164. Once sliding switch 164 is stroked once more toward the A direction, the exoskeleton speed will be increased to the medium value. Finally, a third stroke of sliding switch 164 toward the A direction causes exoskeleton 102 to move with its maximum value. The user can decrease the speed similarly by moving spring-loaded sliding switch 164 toward the B direction. A stroke on spring loaded sliding switch 164 toward the B direction will command exoskeleton 102 to decrease its speed. For example, if exoskeleton 102 is moving with its maximum speed, a stroke toward the B direction will command exoskeleton 102 to change its speed to the medium value. If exoskeleton 102 is moving with its minimum speed, a stroke toward the B direction will command exoskeleton 102 to stop. Although depicted on a crutch 136′, it should be understood that sliding switch 164 can be mounted on one or more crutches, on a cane or on a walker.

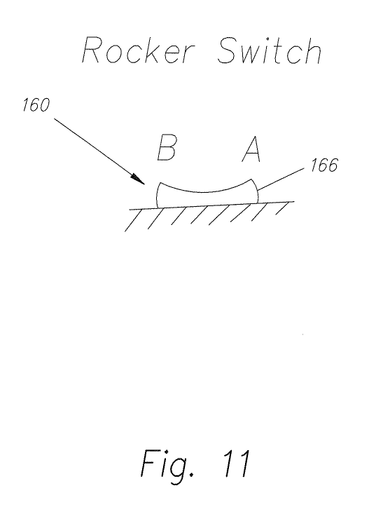

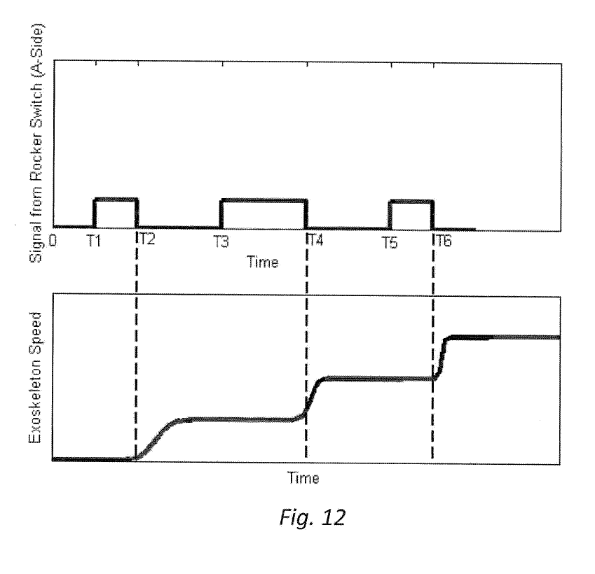

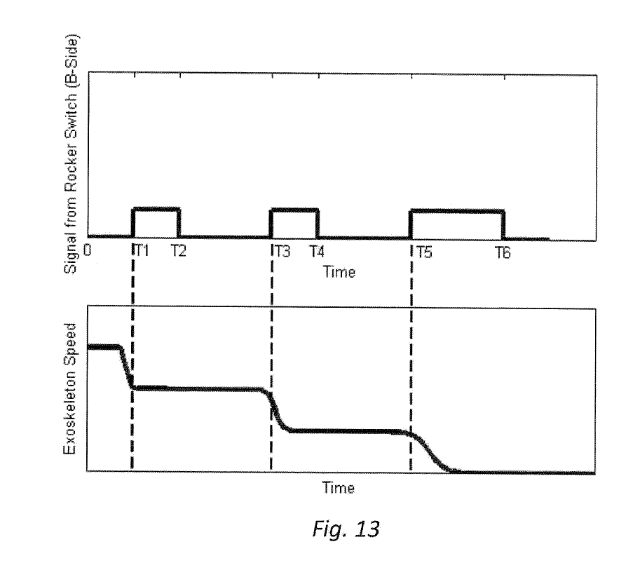

In another embodiment of the present invention, user control 160 is in the form of a rocker switch 166, as is depicted in FIG. 11. When the user pushes rocker switch 166 on the A side, then exoskeleton controller 130 knows that the exoskeleton speed should be increased by some amount. When the other side of rocker switch 166 (labeled B) is pushed down, then exoskeleton controller 130 will decrease the exoskeleton speed. Similar to spring-loaded sliding switch 164, one can increase the exoskeleton speed by a predetermined amount by pushing once on the A side of the rocker switch 166. The user can decrease the exoskeleton speed by a predetermined amount when the B side of rocker switch 166 is pressed once. In this case, the speed of exoskeleton 100 is a function of frequency (how many times) rocker switch 166 is pushed. FIG. 12 shows the signal from rocker switch 166 as a function of time. At T₁, rocker switch 166 is pressed on its A side. At T₂, rocker switch 166 is released. This commands exoskeleton 102 to increase its speed. At time T₃, the user presses rocker switch 166 one more time on its A side and releases it at T₄. This causes one more incremental increase on the exoskeleton speed. Finally the user presses on the A side of rocker switch 166 at time T₅ and releases it at time T₆. This causes one more increase in the velocity for exoskeleton 102. Similarly, when rocker switch 166 is pressed on its B side, exoskeleton controller 130 decreases the exoskeleton speed as shown in FIG. 13. T₁ represents the time that rocker switch 166 is pressed on its B side. T₂ represents the time that rocker switch 166 is released. At time T₁, exoskeleton 102 is commanded to decrease its speed. At time T₃, rocker switch 166 is pressed once more on its B side. This causes the exoskeleton speed to decrease again. At time T₅, rocker switch 166 is pressed one more time on its B side which commands exoskeleton 102 to stop.

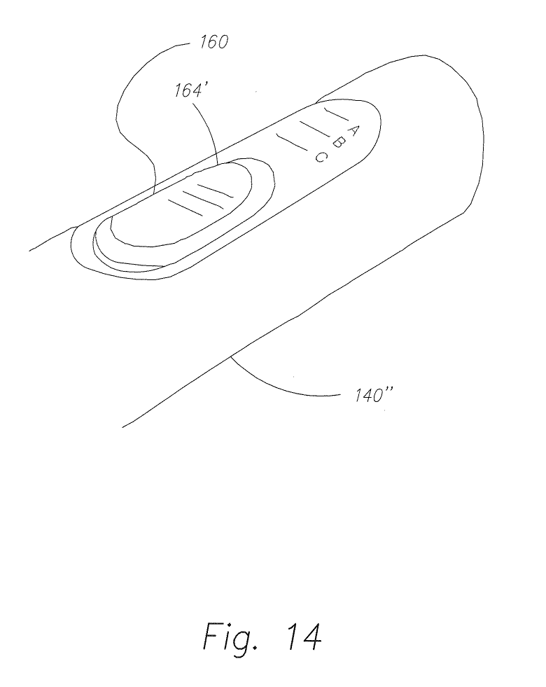

FIG. 14 shows an alternative sliding switch 164′ on crutch handle 140″. As can be seen from FIG. 14, sliding switch 164′ can be moved to position A, position B, and position C. When sliding switch 164′ is moved to position A by the user, exoskeleton 102 moves with a slow speed. When sliding switch 164′ is moved to position B by the user, exoskeleton 102 moves with medium speed. When sliding switch 164′ is moved by the user to position C, exoskeleton 102 moves with a fast speed. Although depicted on a crutch handle 140″, it should be understood that the sliding switch 164′ can alternatively be located on a walker 148. As can be observed in the embodiment of FIG. 14, the location of sliding switch 164′ determines the exoskeleton speed. As long as sliding switch 164′ is in a particular position, the exoskeleton speed remains constant. For example, if sliding switch 164′ is moved to position B by the user, the exoskeleton speed reaches a medium speed and remains at medium speed until the operator moves sliding switch 164′ to another location. The difference between this embodiment and previous embodiments, is that the location of sliding switch 164′ assigns a speed for exoskeleton 102.

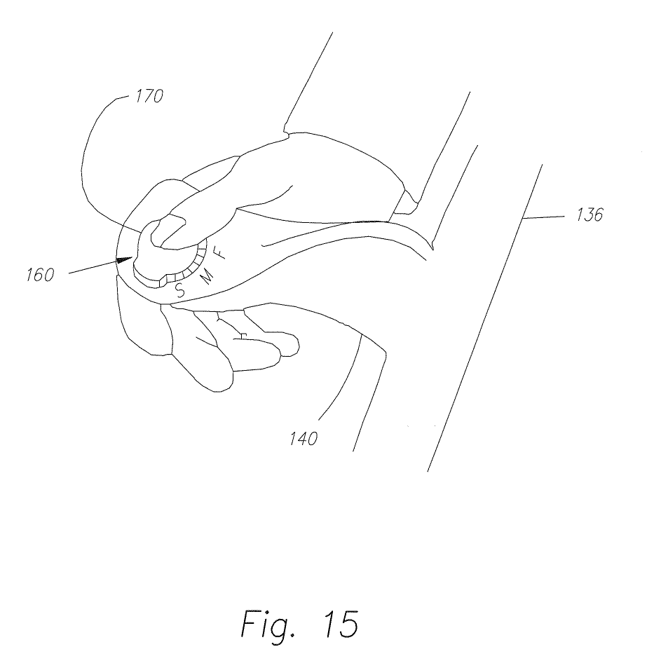

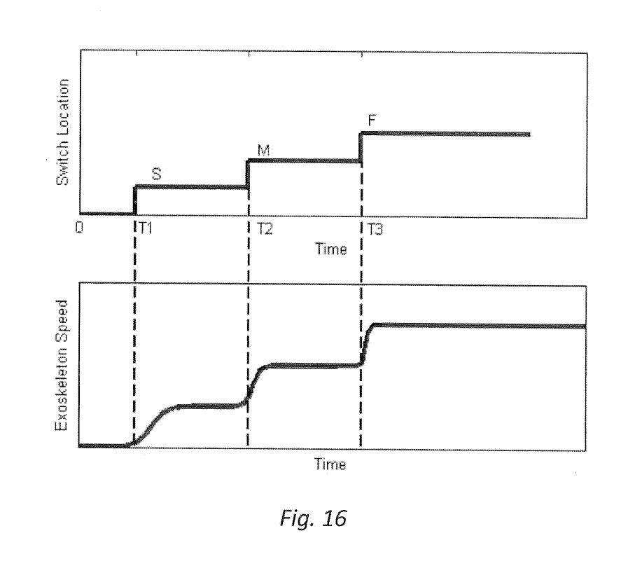

FIG. 15 shows another user control 160 that functions similar to sliding switch 164′ of FIG. 14, but is rotary. Rotary switch 170 generally functions the same way as sliding switch 164′ of FIG. 14 functions. When rotary switch 170 is rotated to position S, exoskeleton 102 is commanded to move slowly. When rotary switch 170 is moved to position M, exoskeleton 102 is commanded to move with medium speed, and finally, when rotary switch 170 is moved to position F, exoskeleton 102 is commanded to move fast. FIG. 16 shows the plot of the switch location as a function of time and exoskeleton speed. At time T₁, rotary switch 170 is moved to position S. This commands exoskeleton 102 to go (i.e., walk) with slow speed. At time T₂, rotary switch 170 is positioned at location M. This commands exoskeleton 102 to move with medium speed. When rotary switch 170 is moved to position F, exoskeleton 102 is commanded to move with its maximum speed. The “slow, ” “medium,” and “fast” speed can be preprogrammed in exoskeleton controller 130 as desired. Depending on the user's comfort and ability for locomotion and stabilization, the various speeds can be programmed through an interface device (not separately shown) of signal generator 142. Of course, one can create a rotary or sliding position with more positions such as very slow, slow, medium, and fast. Although depicted on a crutch handle 140, it should be understood that rotary switch 170 could be located on a walker 148.

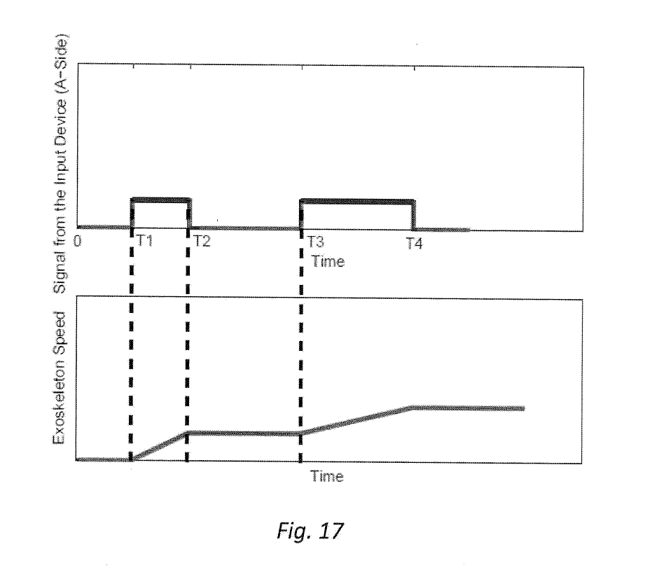

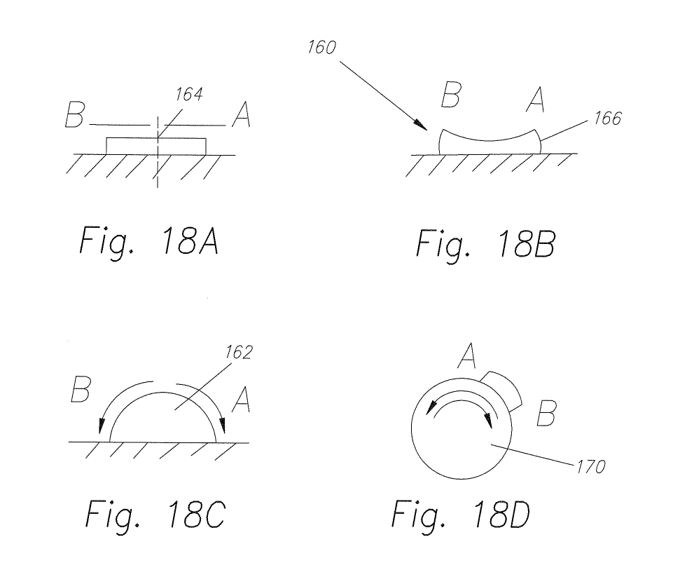

In some embodiments of the invention, the duration that user control 160 (e.g., a spring-loaded thumbwheel, spring-loaded sliding switch, spring-loaded rotary switch, or a rocker switch) is pressed assigns a command for the exoskeleton velocity. FIG. 17 shows the time plot of the signal generated by one of these user controls 160 as a function of the time. This figure also shows the commanded exoskeleton speed. For example, between time T₁ and T₂ when user control 160 is pressed on its A side, the exoskeleton speed increases. Once the user releases user control 160, the exoskeleton speed remains constant. At time user control 160 is pressed again on its A side. The exoskeleton speed increases as long as user control 160 is pressed on its A side. Similarly the exoskeleton speed decreases when the B side of user control 160 is activated. FIGS. 18A-18D show the A and B positions of a variety of user controls 160, including a sliding switch 162, a rocker switch 166, a thumbwheel 162 and a rotary switch 170.

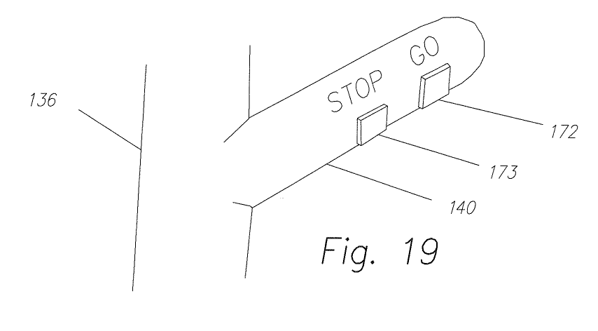

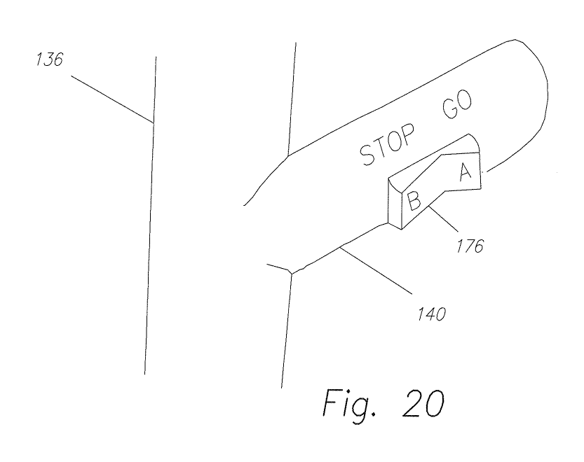

In some embodiments of the invention, simpler user controls 160 can be integrated into crutches and walkers. For example, FIG. 19 shows a situation where a crutch 136 includes a user control 160 in the form of two buttons 172, 173 corresponding to “On” or “Go” (i.e., walk) and “Off” or “Stop”. When the “Go” button 172 is activated, exoskeleton 102 takes on a particular speed. When the “Stop” button 173 is activated, exoskeleton controller 130 stops exoskeleton 102. In some embodiments of the invention, an additional stroke on the “Go” button 172 will increase the exoskeleton speed. When the “Stop” button 173 is pushed, then the exoskeleton speed decreases. Repeated strokes on the “Stop” button 173 will cause exoskeleton 102 to eventually stop. In some embodiments of the invention there is a button incorporated into the crutch to stop exoskeleton 102 as fast as possible (i.e., within a step). Practitioners can find variety of methods to program the two buttons 172, 173 of FIG. 19 to yield intuitive and safe commands for exoskeleton 102. FIG. 20 shows a similar embodiment of the invention wherein user control 160 is in the form of a rocker switch 176 with two positions, which is integrated in crutch 136 to control the exoskeleton speed. When rocker switch 176 is pressed on its “Go” side, exoskeleton 102 moves and when rocker switch 176 is pressed on its “Stop” side, exoskeleton controller 130 stops exoskeleton 102.

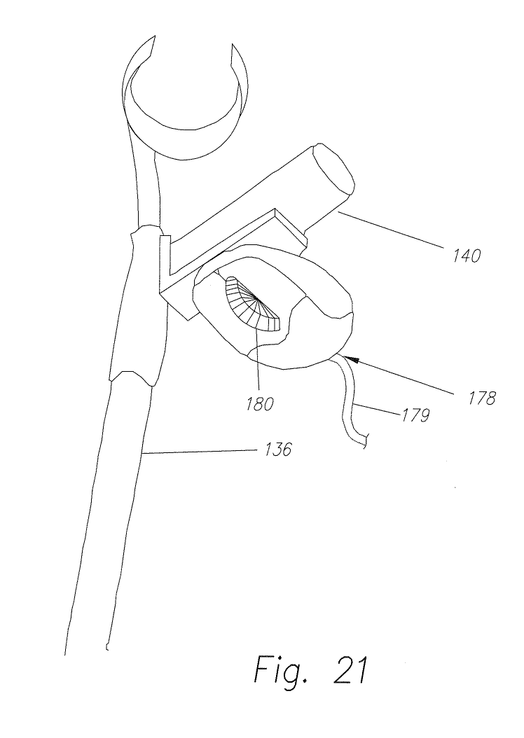

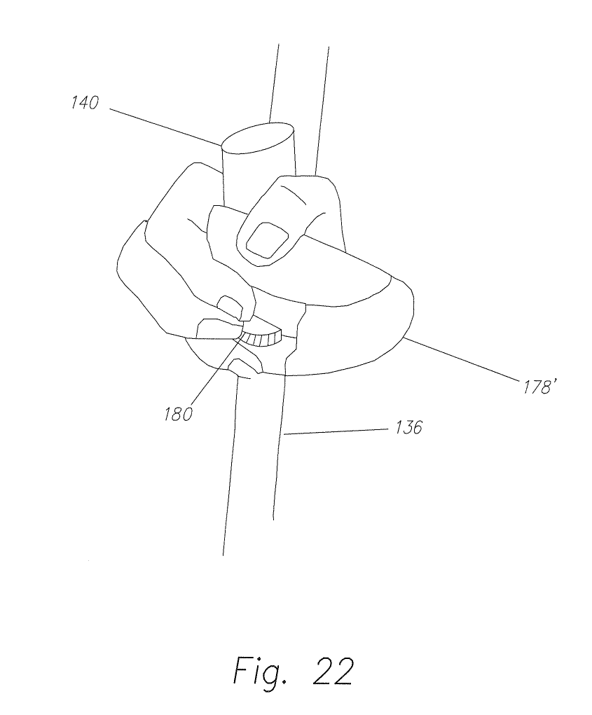

In some embodiments of the invention, user control 160 is in the form of a computer mouse 178 to command exoskeleton 102, as depicted in FIG. 21. Although depicted on a crutch 136, computer mouse 178 can equally be installed on a walker 148. If computer mouse 178 uses a wire to send information, then a USB output of the computer mouse 179 can be connected to exoskeleton controller 130 to send commands from computer mouse 178 to the exoskeleton controller 130. If computer mouse 178 is wireless, then the information from computer mouse 178 can be sent to exoskeleton controller 130 wirelessly. FIG. 22 shows a wireless computer mouse 178′ in an alternative configuration with respect to crutch handle 140. The orientation of the computer mouse depends on the users comfort and preference. Computer mouse 178, 178′ preferably has a thumbwheel 180. Thumbwheel 180 rotation created by the user can signal exoskeleton controller 130 to command exoskeleton 102 to move or perform various functions. Commanding exoskeleton 102 using mouse thumbwheel 180 is similar to commanding exoskeleton 102 using thumbwheel 162 shown in FIG. 3. In some embodiments of the invention, if mouse thumbwheel 180 is rotated forward once (e.g., stroked once along the forward direction), then exoskeleton 102 moves forward with a particular speed. If the user turns mouse thumbwheel 180 once more (e.g., strokes once more), then exoskeleton 102 moves a little faster. One can program exoskeleton controller 130 such that every time the user strokes mouse thumbwheel 180, a small amount of velocity is added to the exoskeleton speed. When the user turns mouse thumbwheel 180 (i.e., strokes the thumbwheel) in the opposite direction, the exoskeleton's speed will be reduced. In summary, every stroke on mouse thumbwheel 180 will increase or reduce the exoskeleton speed.

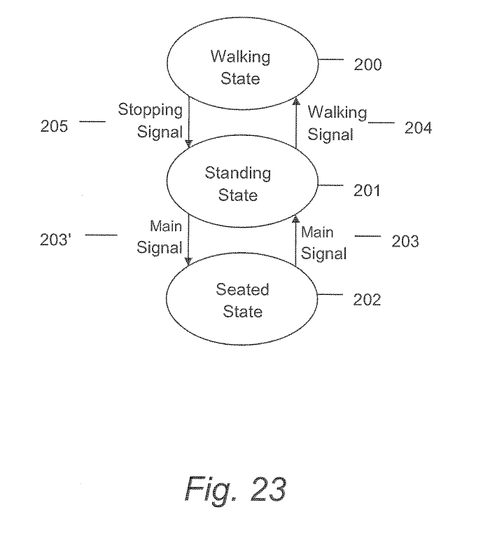

Methods of controlling exoskeleton 102 through various states will now be discussed in more detail. A finite state machine (not individually shown) is a part of a software controller that is located at the heart of exoskeleton controller 130 and basically decides what exoskeleton 102 should do. This finite state machine moves exoskeleton 102 from one state to another state based on various signals issued from signal generator 142 of support device 104, and/or another user control device. As can be seen from FIG. 23, the finite state machine recognizes, among other states, a Walking State 200, a Standing State 201, and a Seated State 202. In one method of use, when exoskeleton 102 is turned on, exoskeleton 102 is in the Seated State 202. Assuming the person is being coupled to or donning exoskeleton 102 when seated on a chair or on a couch, then one can consider the Seated State 202 as the last stage of the donning procedure. Exoskeleton 102 moves to the Standing State 201 from the Seated State 202 when the exoskeleton is in the Seated State 202 and a main signal 203 is generated by a user control. Exoskeleton 102 moves to the Walking State 200 from the Standing State 201 when exoskeleton 102 is in the Standing State 201 and a walking signal 204 is generated. Exoskeleton 102 moves to the Standing State 201 from the Walking State 200, when exoskeleton 102 is in the Walking State 200 and a stopping signal 205 is again generated. Exoskeleton 102 moves to the Seated State 202 from the Standing State 201, when exoskeleton 102 is in the Standing State 201 and a second main signal 203′ is generated. Preferably, a user control 160 on a crutch or walker constitutes a main signal generator to generator main signal 203, a walking signal generator for generating walking signal 204, and/or a stopping signal generator for generating stopping signal 205, wherein the main, walking and stopping signals constitute three separate and distinct signal types.

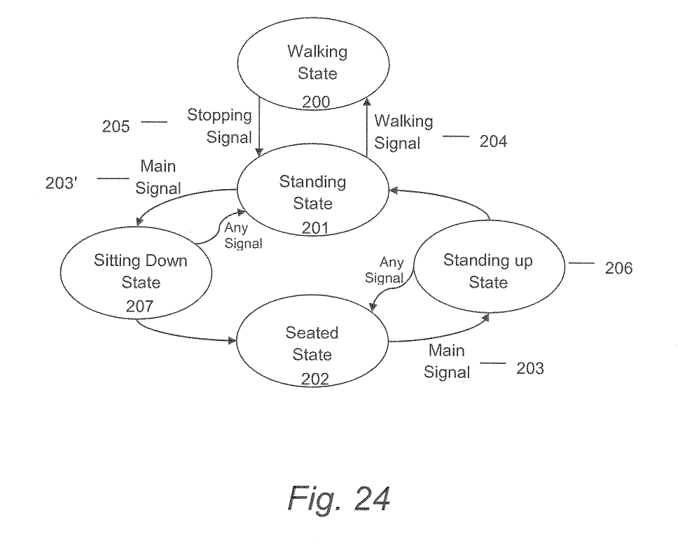

As diagrammed in FIG. 24, exoskeleton 102 passes through a Standing Up State 206 before arriving at a Standing State 201, wherein during Standing Up State 206, both exoskeleton knee joints 114, 115 and hip joints 122 extend from a bent posture assumed in the seated position to a straight posture. In some embodiments of the invention, generating any signal during Standing Up State 206 will return exoskeleton 102 to Seated State 202. This allows the user to abort the shift between operational positions of exoskeleton 102 and bring it back to Seated State 202. It can also be understood that exoskeleton 102 passes through a Sitting Down State 207 before moving to Seated State 202 wherein during Sitting Down State 207, both exoskeleton knee joints 114, 115 and hip joints 122 flex from a straight posture assumed in the standing position to a bent posture. In some embodiments of the invention, generating any signal during Sitting Down State 207 will return exoskeleton 102 to Standing State 201. This allows the user to abort the shift between operational positions of exoskeleton 102 and bring it back to Standing State 201.

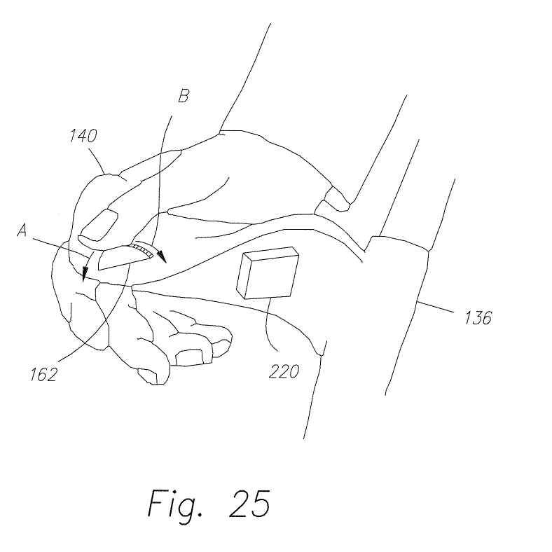

In accordance with one method of the present invention, generating a walking signal 204, when exoskeleton 102 is in the Walking State 200, causes exoskeleton 102 to increase its speed. In the example depicted in FIG. 25, when a user rotates a thumbwheel 162 in a first direction A, a walking signal 204 for a particular speed is generated. The user then rotates thumbwheel 162 one more time in the same direction to generate another walking signal 204. The second walking signal 204 commands exoskeleton 102 to increase its speed. Alternatively, instead of utilizing the second walking signal 204 to increase the exoskeleton speed, a fast signal generated when exoskeleton 102 is in the Walking State 200 causes exoskeleton 102 to increase its speed. In this embodiment, the fast signal is different from the walking signal 204. Generating a stopping signal 205, when exoskeleton 102 is in the Walking State 200, causes exoskeleton 102 to decrease its speed. In the example of FIG. 25, a user rotates thumbwheel 162 once in a second direction B to generate the stopping signal 205. This stopping signal 205 commands exoskeleton 102 to decrease its speed. The user then rotates thumbwheel 162 one more time in the same direction to generate another stopping signal 205. The second stopping signal 205 commands exoskeleton 102 to stop. Instead of generating the stopping signal 205 to decrease the exoskeleton speed, in some embodiments of the invention, generating a slow signal when exoskeleton 102 is in the Walking State 200 causes exoskeleton 102 to decrease its speed. In this embodiment, the slow signal is different from the stopping signal 204.

In accordance with one method of the present invention, the step of generating a main signal 203 when exoskeleton 102 is in the Seated State 202 includes generating a first signal followed by generating at least a second signal confirming the user's intention, wherein there is a sufficient amount of time between the first and second signals for the controller to properly process the first and second signals. In operation, the user generates a first signal when the device is in the Seated State 202, declaring that the user intends to stand up. Exoskeleton controller 130 then sends a feedback message (in terms of voice, sound, LED light, or vibration to the user) declaring the receipt of such command. The user then generates the second signal completing the generation of main signal 203. In some embodiments of the invention, the step of generating the main signal 203 when exoskeleton 102 is in the Standing State 201 includes generating a third signal followed by generating at least a fourth signal confirming the user's intention. In operation, the user generates a third signal when exoskeleton 102 is in the Standing State 201, declaring that the user intends to sit down. Exoskeleton controller 130 then sends a feedback message (in terms of voice, sound, LED light, or vibration to the user) declaring the receipt of such command. The user then generates a fourth signal completing the generation of main signal 203.

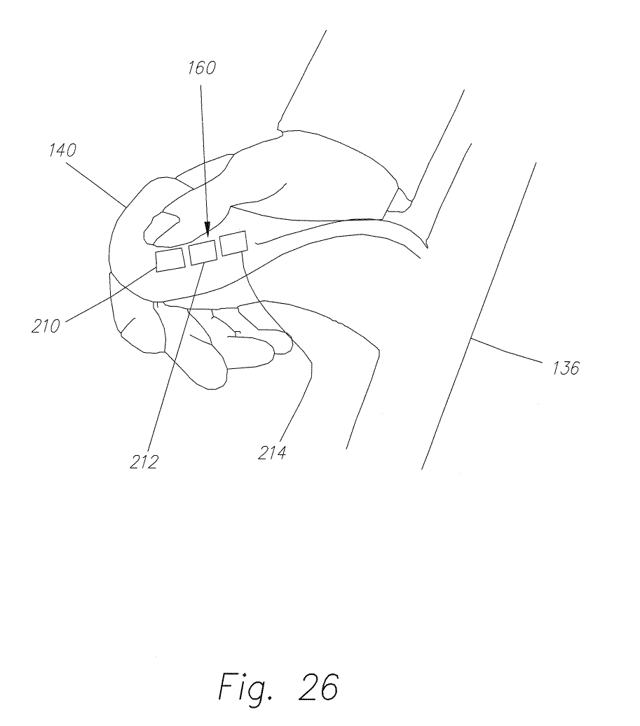

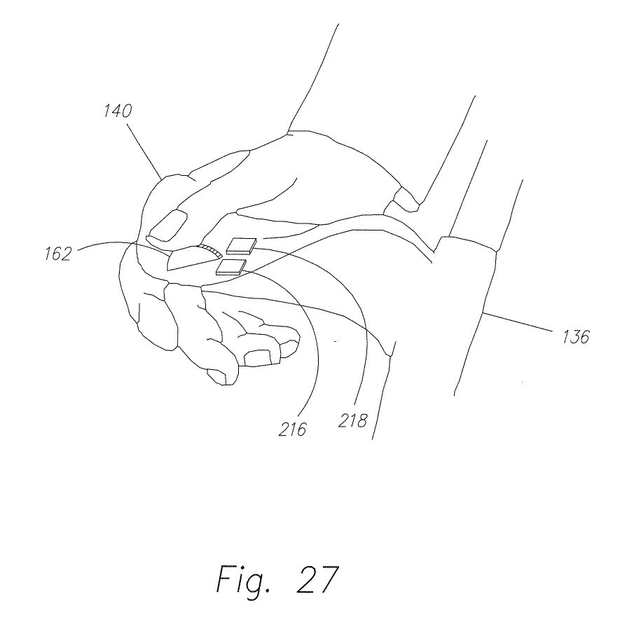

FIG. 26 shows an embodiment where user control 160 includes a main signal generator 210, a walking signal generator 212, and a stopping signal generator 214. In operation, the act of generating main signal 203, walking signal 204 and stopping signal 205 are accomplished by separately activating main signal generator 210, walking signal generator 212, and stopping signal generator 214, respectively. FIG. 27 shows another embodiment where the acts of generating stopping signal 205 and main signal 203 are accomplished by two separate pushbuttons 216 and 218. In operation, the act of generating stopping signal 205 and main signal 203 are accomplished by pushing pushbuttons 216 and 218, respectively. FIG. 27 further shows that thumbwheel 162 acts as a walking signal generator, and the act of generating walking signal 204 is accomplished by rolling the thumbwheel 162, as discussed in previous embodiments.

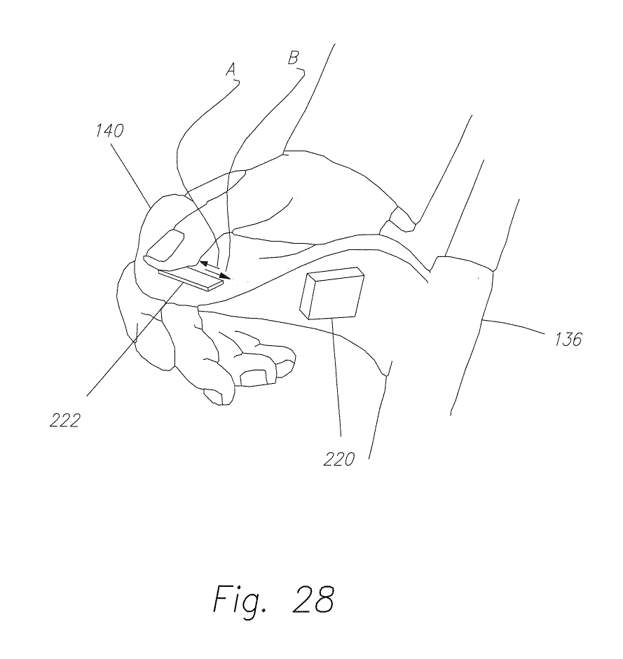

In some embodiments of the invention, a single walking-stopping signal generator generates walking signal 204 and stopping signal 205. In some embodiments of the invention, the single walking-stopping signal generator is coupled either to a walker or a crutch held by the user. For example, FIG. 25 shows an embodiment where the single walking-stopping signal generator is thumbwheel 162, walking signal 204 is generated by rolling thumbwheel 162 along direction A, and the act of generating stopping signal 205 is accomplished by rolling thumbwheel 162 along the opposite direction B. FIG. 25 also illustrates an embodiment where the main signal generator is a pushbutton 220 and the act of generating main signal 203 is accomplished by activating pushbutton 220. FIG. 28 shows another embodiment where the single walking-stopping signal generator is in the form of a sliding switch 222, the act of generating walking signal 204 is generated by sliding switch 222 along direction A and the act of generating stopping signal 205 is accomplished by sliding switch 222 along direction B. FIG. 28 also shows that pushbutton 220 acts as a main signal generator.

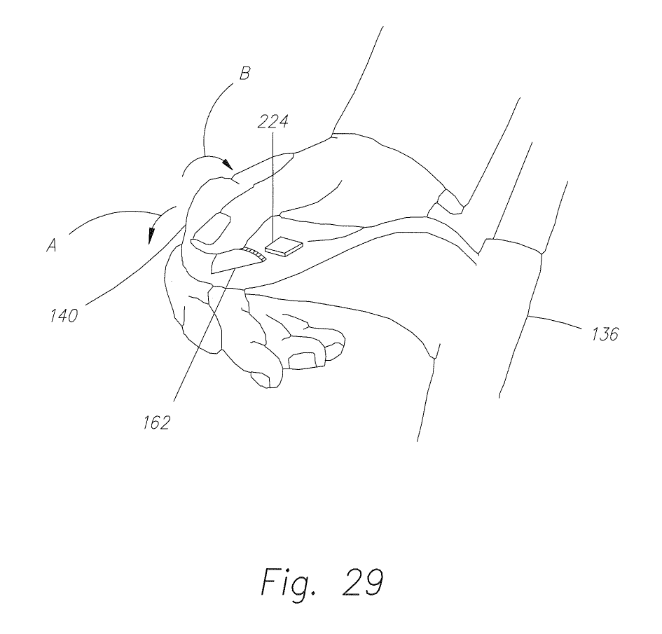

In some embodiments of the invention as shown in FIG. 29, stopping signal 205 is generated by a stopping signal generator in the form of a push-button 224, while walking signal 204 and main signal 203 are generated by a single main-walking signal generator in the form of thumbwheel 162. In this embodiment, walking signal 204 is generated by rolling thumbwheel 162 along direction A, and the act of generating main signal 203 is accomplished by rolling thumbwheel 162 along direction B. Referring back to FIG. 28, in another embodiment, the single main-walking signal generator is in the form of sliding switch 222, the act of generating walking signal 204 is generated by sliding switch 222 along direction A, and the act of generating main signal 203 is accomplished by sliding switch 222 along direction B.

Referring back to FIG. 29, in some embodiments of the invention, walking signal 204 is generated by a walking signal generator in the form of pushbutton 224 while stopping signal 205 and main signal 203 are generated by a single main-stopping signal generator in the form of thumbwheel 162. The act of generating walking signal 204 is generated by pushing pushbutton 224, the act of generating walking signal 204 is generated by rolling thumbwheel 162 along direction A, and the act of generating main signal 203 is accomplished by rolling thumbwheel 162 along another direction B. In another embodiment, sliding switch 222 of FIG. 28 is a single main-stopping signal generator, stopping signal 205 is generated by sliding switch 222 along direction A, and the act of generating main signal 203 is accomplished by sliding switch 222 along direction B.

In some embodiments of the invention, main signal 203, walking signal 204, and stopping signal 205 are generated by a universal signal generator. For example, referring back to FIG. 3, a universal signal generator may be in the form of thumbwheel 162. In operation, the act of generating walking signal 204 is accomplished by rolling thumbwheel 162 along direction A and the act of generating stopping signal 205 is accomplished by rolling thumbwheel 162 along direction B. The act of generating main signal 203 is accomplished by pushing thumbwheel 162 downward along arrow C. Alternatively, referring back to FIG. 14, a universal signal generator maybe in the form of sliding switch 164′. In operation, the act of generating walking signal 204 is accomplished by sliding switch 164′ to position C, the act of generating stopping signal 205 is accomplished by sliding switch 164′ to position B, and the act of generating main signal 203 is accomplished by sliding switch 164′ to position A.

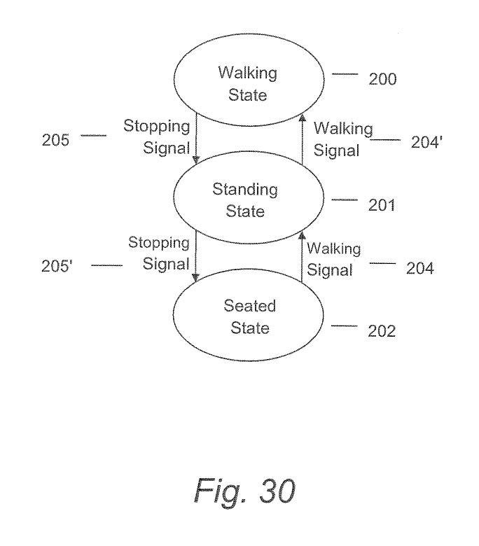

Another method of transitioning exoskeleton 102 between various states will now be discussed with reference to FIG. 30. Similar to the method shown in FIG. 23, when exoskeleton 102 is turned on, exoskeleton 102 is in the Seated State 202. Assuming the person is putting exoskeleton 102 on (donning) when seated on a chair or on a couch, then one can consider the Seated State 202 is the last stage of the donning procedure. Exoskeleton 102 moves to Standing State 201 from the Seated State 202, when exoskeleton 102 is in the Seated State 202 and a walking signal 204 is generated. Exoskeleton 102 moves to the Walking State 200 from the Standing State 201 when exoskeleton 102 is in the Standing State 201 and a second walking signal 204′ is generated. Exoskeleton 102 moves to the Standing State 201 from the Walking State 200 when exoskeleton 102 is in the Walking State 200 and stopping signal 205 is generated. Exoskeleton 102 moves to the Seated State 202 from the Standing State 201 when exoskeleton 102 is in the Standing State 201 and a second stopping signal 205′ is generated. In this example, the walking signals 204, 204′ and stopping signals 205, 205′ constitute two types of separate and distinct signals.

As noted above, in accordance certain methods of the present invention, generating the Walking Signal 204, when exoskeleton 102 is in the Walking State 200, causes exoskeleton 102 to increase its speed. For example, referring back to FIG. 3, the user rotates thumbwheel 162 once (along direction A) to generate a walking signal 204 with a particular speed. The user then rotates thumbwheel 162 one more time along direction A to generate another walking signal 204′. The second walking signal 204′ commands exoskeleton 102 to increase its speed. Instead of generating walking signal 204′ to increase the exoskeleton speed, in some embodiments of the invention, generating a fast signal when the exoskeleton is in the walking state causes exoskeleton 102 to increase its speed. In this embodiment, the fast signal is generated by generating two (or more) walking signals. Similarly, in some embodiments of the invention, generating a stopping signal 205, when exoskeleton 102 is in the Walking State 200, causes exoskeleton 102 to decrease its speed. With reference to FIG. 3, a user rotates thumbwheel 162 once (along direction B) to generate a stopping signal 205. This stopping signal 205 commands exoskeleton 102 to decrease its speed. The user then rotates thumbwheel 162 one more time along direction B to generate another stopping signal 205′. The second stopping signal 205′ commands exoskeleton 102 to stop. Instead of generating stopping signal 205′ to decrease the exoskeleton speed, in some embodiments of the invention, generating a slow signal, when exoskeleton 102 is in the Walking State 200, causes exoskeleton 102 to decrease its speed. In this embodiment slow signal is different from the stopping signal.

In some embodiments of the invention, the step of generating the walking signal 204 when exoskeleton 102 is in the Seated State 202 includes generating a first signal followed by generating at least a second signal confirming the user's intention. In operation, the user generates a first signal when exoskeleton 102 is in the Seated State 202 declaring that the user intends to stand up. Exoskeleton controller 130 then sends a feedback message (in terms of voice, sound, LED light, or vibration to the user) declaring the receipt of such command. The user then generates the second signal completing the generation of the walking signal 204. In some embodiments of the invention, the step of generating the stopping signal 205 when exoskeleton 102 is in the Standing State 201 includes generating a third signal followed by generating at least a fourth signal confirming the user's intention. In operation, the user generates a third signal when exoskeleton 102 is in the Standing State 201 declaring that the user intends to sit down. Exoskeleton controller 130 then sends a feedback message (in terms of voice, sound, LED light, or vibration to the user) declaring the receipt of such command. The user then generates a fourth signal completing the generation of the stopping signal 205.

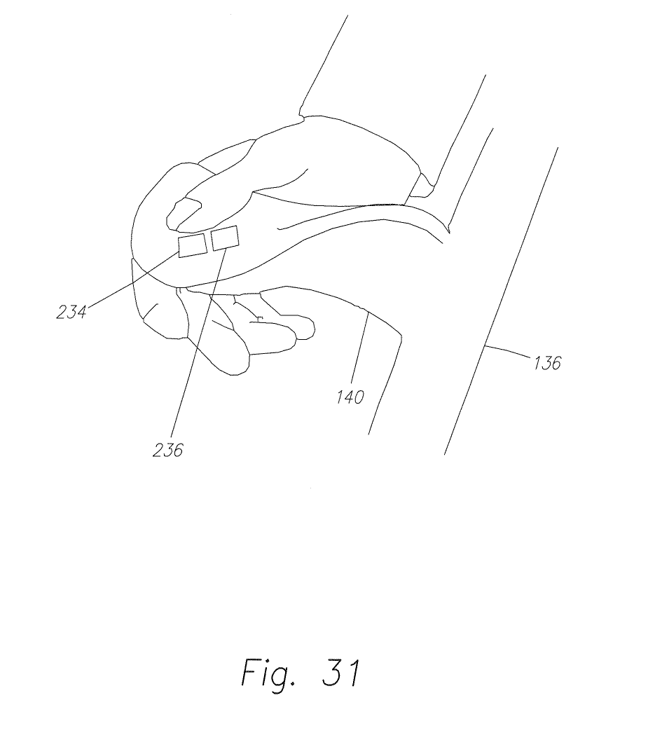

In one embodiment depicted in FIG. 31, a walking signal generator is in the form of a pushbutton 234 and a stopping signal generator is in the form of a separate pushbutton 236. In operation, the act of generating the walking signal 204 and the stopping signal 205 are accomplished by separately activating the walking signal generator 234 and the stopping signal generator 236. Referring back to FIG. 25, in another embodiment the walking signal generator is in the form of thumbwheel 162, the act of generating the walking signal 204 is accomplished by rolling thumbwheel 162 along direction A, and the stopping signal 205 is activated by pushbutton 220.

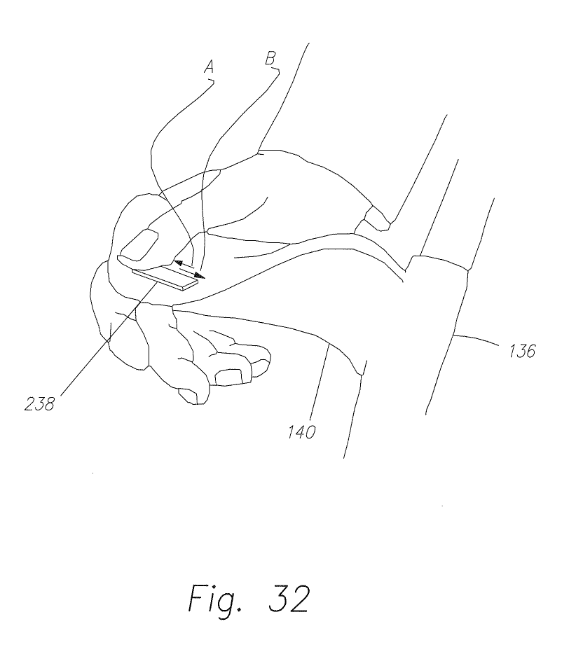

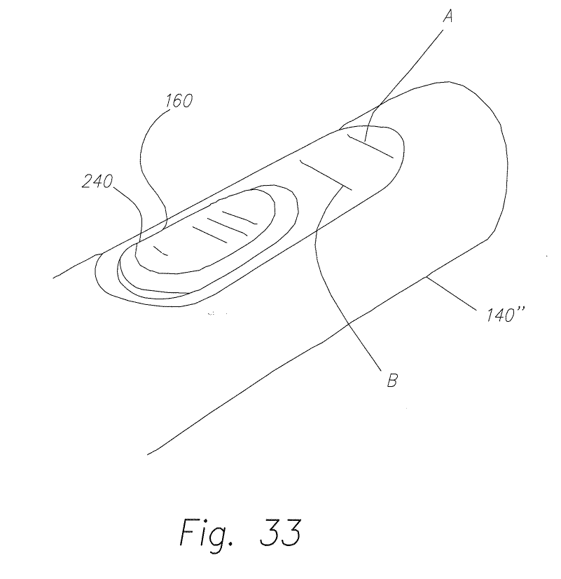

Referring back to FIG. 3, in one embodiment, a single walking-stopping signal generator is in the form of thumbwheel 162, the act of generating the walking signal 204 is generated by rolling thumbwheel 162 along direction A, and the act of generating the stopping signal 205 is accomplished by rolling thumbwheel 162 along the opposite direction B. FIG. 32 shows another embodiment wherein a walking-stopping signal generator is in the form of a sliding switch 238 and the act of generating the walking signal 204 is generated by sliding switch 238 along direction A and the act of generating the stopping signal 205 is accomplished by sliding switch 238 along direction B. FIG. 33 shows yet another embodiment where a walking-stopping signal generator is in the form of a sliding switch 240. In operation, the act of generating the walking signal 204 is accomplished by sliding switch 240 to position A. The act of generating the stopping signal 205 is accomplished by sliding switch 240 to position B.

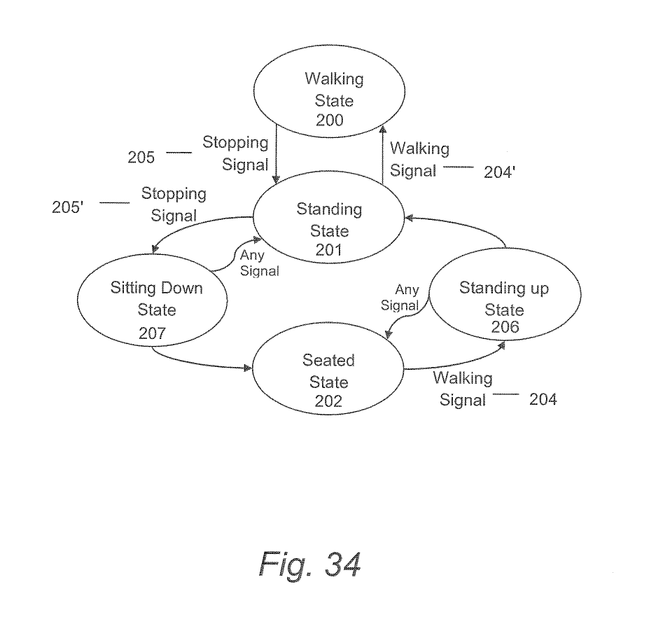

As diagrammed in FIG. 34, exoskeleton 102 passes through Standing Up State 206 before moving to the Standing State 201, wherein during the Standing Up State 206 both the exoskeleton knee joints 114, 115 and hip joints 122 extend from a bent posture assumed in the seated position to a straight posture. As noted above, in some embodiments of the invention, generating any signal during the Standing Up State 206 will return exoskeleton 102 to the Seated State 202. This allows the user to abort the shift between operational positions of exoskeleton 102 and bring it back to the Seated State 202. It can also be understood that exoskeleton 102 passes through Sitting Down State 207 before moving to the seated state wherein during the Sitting Down State 207 both the exoskeleton knee joints 114, 115 and hip joints 122 flex from straight posture assumed in the standing position to the bent posture. In some embodiments of the invention, generating any signal during the Sitting Down State 207 will return exoskeleton 102 to the Standing State 201. This allows the user to abort the exoskeleton and bring it back to the standing state.

As should be understood from the above, the various user controls 160 on signal generators 142 utilized in accordance with the present invention can be in the form of separate user controls, combined user controls, or a combination of both. The signal generators 142 may comprise an element or combination of elements selected from the group consisting of: pushbuttons, switches including, momentary switches, rocker switches, sliding switches, capacitive switches, and resistive switches, thumbwheels, thumb balls, roll wheels, track balls, keys, knobs, potentiometers, encoders, or linear variable differential transformers (LVDTs). As explained above, in some embodiments of the invention, at least one of the user controls 160 is activated by one or any combination of the user's fingers.

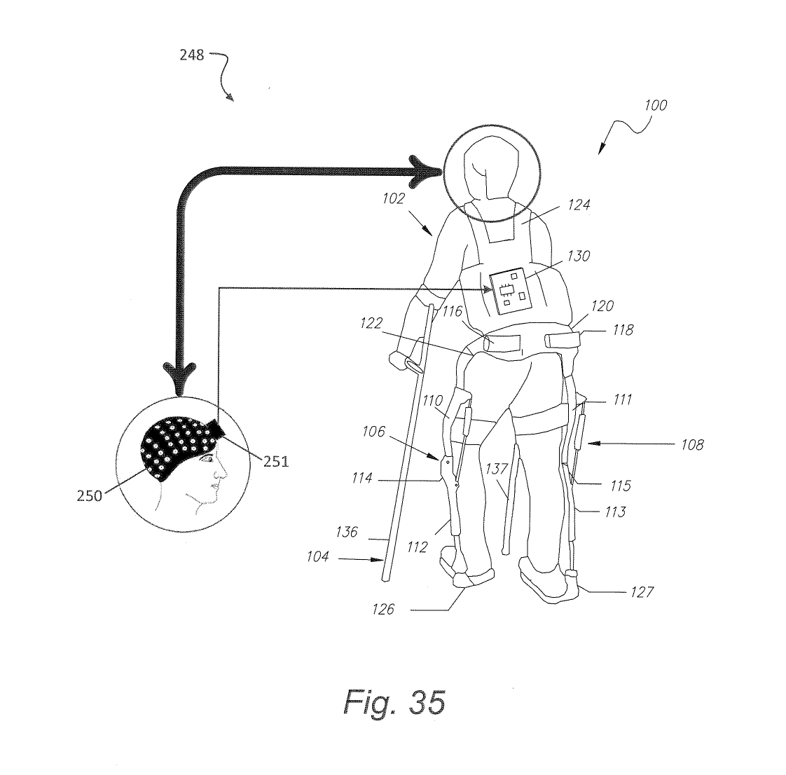

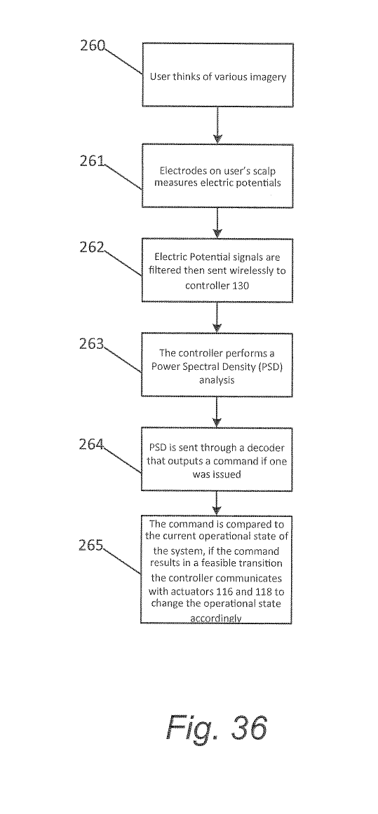

In some embodiments of the invention, as shown in FIG. 35, at least one of the main signal 203, walking signal 204 or stopping signal 205 is generated by a brain signal recognition system 248 that accepts and processes a user's brain signals. In general, brain recognition system 248 includes a brain machine interface (BMI) 250 and a processor 251 configured to communicate with exoskeleton controller 130. When brain signal recognition system 248 is used to generate at least one of the main signal 203 or walking signal 204, or stopping signal 205, then, in some embodiments of the invention, a switch (not shown) is employed to enable or disable the brain signal generator. In this case, the user needs to push on this enable-disable switch before or during commanding exoskeleton 102. This ensures that brain signal recognition system 248 does not accept random commands from either the user or other sources. An embodiment of transitioning exoskeleton 102 between various states is discussed with reference to FIG. 36. When the user thinks of various imagery 260 which correspond to either A main signal 203, walking signal 204, or stopping signal 205, electric potentials corresponding to the thought are elicited. The electric potentials in the user's brain are measured by BMI 250 on the user's scalp in process 261. In process 262 the electric potential signals are filtered by processor 251 and are transmitted to exoskeleton controller 130 through wires or wirelessly. In process 263 the controller 130 performs a Power Spectral Density (PSD) analysis to transform the electric potential data from the time domain to the frequency domain. In process 264 the frequency domain data is sent to a decoder within controller 130 which maps the data over various frequencies to a potential exoskeleton command. In some embodiments, the decoder could take the form of an Artificial Neural Network which is a method of creating a mapping for complex nonlinear processes such as electrical potential PSD data to an exoskeleton command such as main signal 203, walking signal 204, or stopping signal 205. In process 265 the exoskeleton command is compared to the current operational state of the exoskeleton system, and if the command results in a feasible transition, controller 130 communicates with actuators 116 and 118 to change the exoskeleton state accordingly. If the command results in an infeasible transition in the operational state of exoskeleton 102, the command is ignored and the BMI 250 continues to measure the user's brain electric potentials at the user's scalp.

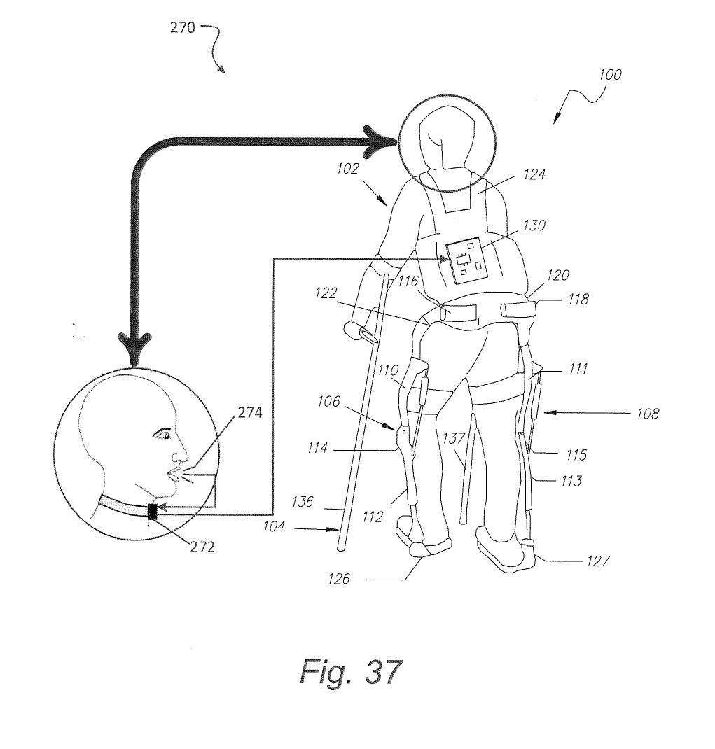

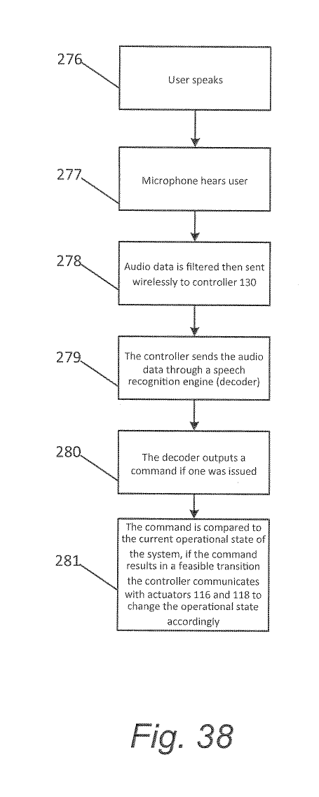

In some embodiments of the invention, as shown in FIG. 37, at least one of the main signal 203, walking signal 204, or stopping signal 205 is generated by a voice universal signal generator 270 that accepts and processes the user's auditory inputs. In some embodiments of the invention, voice universal signal generator 270 is coupled to a crutch or a walker, while in other embodiments, the voice universal signal generator 270 is coupled to the user. In general, voice universal signal generator 270 includes a microphone system 272 and a voice recognition system generally indicated at 274. When voice universal signal generator 270 is used to generate at least one of a main signal 203, walking signal 204, or stopping signal 205, then in some embodiments of the invention, a switch (not shown) is employed to enable or disable voice universal signal generator 270. In this case, the user needs to push on this enable-disable switch before or during commanding exoskeleton 102. This ensures that voice universal signal generator 270 does not accept random commands from either the user or others. This method of transitioning exoskeleton 102 between various states will now be discussed with reference to FIG. 38. In process 276, the user speaks either a word or any other aural gesture which corresponds to either main signal 203, walking signal 204, or stopping signal 205. Microphone system 272 listens to the user in process 277. In process 278 microphone system 272 transmits the audio data (after some optional filtering) to exoskeleton controller 130 either wirelessly or through wire. A speech recognition engine residing within controller 130 interprets the audio data in process 279. In process 280 the speech recognition engine outputs a command if the audio data indicates that the user made an oral gesture that corresponds to a command. In process 281 the command is compared to the current operational state of the system, and if the command results in a feasible transition controller 130 communicates with actuators 116 and 118 to change the exoskeleton state accordingly. If the command results in an infeasible transition in the operational state of exoskeleton 102, the command is ignored and the voice signal recognition system 274 continues to listen to the user waiting for aural input that corresponds to a valid command.

Although described with reference to a preferred embodiment of the invention, it should be readily understood that various changes and/or modifications can be made to the invention without departing from the spirit thereof. For instance, although examples depict various combinations of user controls 160 on crutches 136, 137, a walker 148 or a cane 165, the invention is not limited to combination shown. In general, the invention is only intended to be limited by the scope of the following claims.

I/we claim:

1. An orthesis system comprising:
an exoskeleton configured to be coupled to a user, said exoskeleton comprising:
first and second leg supports configured to be coupled to a user's lower limbs, each of the first and second leg supports including a thigh link;
an exoskeleton trunk configured to be coupled to a user's upper body, said exoskeleton trunk being rotatably connected to each of the first and second leg supports to allow for the flexion and extension between said first and second leg supports and said exoskeleton trunk;
first and second actuators coupled to respective first and second leg supports, said first and second actuators configured to provide movement of the exoskeleton;
an exoskeleton controller configured to shift said exoskeleton between a plurality of operational states and receive user command signals; and
a support device separate from the exoskeleton to be held by a user of the exoskeleton for stabilization, said support device comprising:
at least one support handle;
a signal generator coupled to the support handle and configured to generate and send a user command signal to said exoskeleton controller when activated by a user of the support device, wherein said user command signal causes said exoskeleton controller to shift said exoskeleton between a first operational state and a second operational state.

2. The orthesis system of claim 1, wherein said support device is selected from the group consisting of a walker, a set of crutches, a crutch and a cane.

3. The orthesis system of claim 1, wherein said signal generator includes a user control selected from the group consisting of one or more pushbuttons, switches, thumbwheels, thumb balls, roll wheels, track balls, keys, knobs, potentiometers, encoders, or linear variable differential transformers.

4. The orthesis system of claim 3, wherein said user control is spring loaded to automatically return to a starting position.

5. The orthesis system of claim 1, wherein the first and second operational states are selected from the group consisting of a seated state, a standing state, a walking state, a sitting-down state, a standing up state and a stopping state.

6. The orthesis system of claim 5, wherein the first operational state is a first walking state and the second operational state is a second walking state, wherein the speed of the second walking state is larger than the speed of the first walking state.

7. A support device, separate from an exoskeleton, to be held by a user of the exoskeleton for stabilization, said support device comprising:
at least one support handle;
a signal generator coupled to the support handle and configured to generate and send a user command signal to an exoskeleton controller when activated by a user of the support device, wherein said user command signal is configured to cause an exoskeleton controller to shift an exoskeleton between a first operational state and a second operational state.

8. A method of utilizing an orthesis system including an exoskeleton and a separate support device to be held by a user of the exoskeleton for stabilization, the support device including a signal generator for generating user command signals and the exoskeleton including a controller for shifting the exoskeleton between a seated state, a standing state, and a walking state based on the user command signals, the method comprising:
generating a first main signal when said exoskeleton is in said seated state to cause said exoskeleton to move from said seated state to said standing state;
generating a walking signal when said exoskeleton is in said standing state to cause said exoskeleton to move from said standing state to said walking state;
generating a stopping signal when said exoskeleton is in said walking state to cause said exoskeleton to move from said walking state to said standing state; and
generating a second main signal when said exoskeleton is in said standing state to cause said exoskeleton to move from said standing state to said seated state.

9. The method of claim 8, wherein said support device is selected from the group consisting of a walker, a set of crutches, a crutch and a cane.

10. The method of claim 8, wherein said first and second main signals, walking signal and stopping signal constitute three separate and distinct signal types.

11. The method of claim 8, further comprising:
generating a second walking signal when said exoskeleton is in said walking state to cause said exoskeleton to increase its speed.

12. The method of claim 8, further comprising:
generating an initial stopping signal when said exoskeleton is in said walking state to cause said exoskeleton to decrease its speed.

13. The method of claim 8, further comprising:
generating a fast signal when said exoskeleton is in said walking state to cause said exoskeleton to increase its speed, wherein the fast signal is distinct from the walking signal.

14. The method of claim 8, further comprising:
generating a slow signal when said exoskeleton is in said walking state to cause said exoskeleton to decrease its speed, wherein the slow signal is distinct from the stopping signal.

15. The method of claim 8, wherein the step of generating the first main signal includes generating a first signal followed by generating at least a second signal confirming said user's intention to move from a seated state to a standing state, where there is a sufficient amount of time between the first and second signals for the controller to properly process the first and second signals.

16. The method of claim 8, wherein the step of generating said second main signal includes generating a first signal followed by generating at least a second signal confirming said user's intention to cause said exoskeleton to move from said standing state to said seated state, where there is a sufficient amount of time between said first and second signal for the controller to properly process the first and second signals.

17. The method of claim 8, wherein the step of generating at least one of the first and second main signals, walking signal or stopping signal comprises manipulating one or more user control elements of the signal generator selected from the group consisting of: a pushbutton, a switch, a thumb wheel, a thumb ball, a roll wheel, a track ball, a key, a knob, a linear variable differential transformer and a potentiometer.

18. The method of claim 8, wherein a user control element of the signal generator is utilized to generate only said first and second main signals.

19. The method of claim 8, wherein a user control element of the signal generator is utilized to generate only said walking signal.

20. The method of claim 8, wherein a user control element of the signal generator is utilized to generate only said stopping signal.

21. The method of claim 8, wherein a user control element of the signal generator is utilized to generate only said first and second main signals and said stopping signal.

22. The method of claim 8, wherein a user control element of the signal generator is utilized to generate only said walking and stopping signals.

23. The method of claim 8, wherein a user control element of the signal generator is utilized to generate only said first and second main signals and said walking signal.

24. The method of claim 8, wherein a user control element of the signal generator is utilized to generate each of said first and second main, walking and stopping signals.

25. The method of claim 8, wherein, when the exoskeleton is caused to move from said standing state to said walking state, said exoskeleton passes through a standing up state, the method further comprising:
generating a signal during said standing up state to cause the controller to return the exoskeleton to said seated state.

26. The method of claim 8, wherein, when the exoskeleton is caused to move from said standing state to said seated state, said exoskeleton passes through a sitting down state, the method further comprising:
generating a signal during the sitting down state to cause the controller to return the exoskeleton to said standing state.

27. A method of utilizing an orthesis system including an exoskeleton and a separate support device to be held by a user of the exoskeleton for stabilization, the support device including a signal generator for generating user command signals and the exoskeleton including a controller for shifting the exoskeleton between a seated state, a standing state, and a walking state based on the user command signals, the method comprising:
generating a first walking signal when said exoskeleton is in said seated state to cause said exoskeleton to move from said seated state to said standing state;
generating a second walking signal when said exoskeleton is in said standing state to cause said exoskeleton to move from said standing state to said walking state;
generating a first stopping signal when said exoskeleton is in said walking state to cause said exoskeleton to move from said walking state to said standing state; and
generating a second stopping signal when said exoskeleton is in said standing state to cause said exoskeleton to move from said standing state to said seated state.

28. The method of claim 27, wherein said first and second walking signal and the first and second stopping signal constitute two separate and distinct signal types.

29. The method of claim 27, further comprising:
generating a third walking signal during said walking state to cause said exoskeleton to increase its speed.

30. The method of claim 27, further comprising:
generating a third stopping signal during said walking state to cause said exoskeleton to decrease its speed.

31. The method of claim 27, further comprising:
generating a fast signal when said exoskeleton is in said walking state to cause said exoskeleton to increase its speed, wherein said fast signal is distinct from the first and second walking signals.

32. The method of claim 27, further comprising:
generating a slow signal when said exoskeleton is in said walking state to cause said exoskeleton to decrease its speed, wherein said slow signal is distinct from said first and second stopping signals.

33. The method of claim 27, wherein the step of generating said first walking signal includes generating a first signal followed by generating at least a second signal confirming said user's intention to cause said exoskeleton to move from the seated state to the standing state, where there is a sufficient amount of time between said first signal and said second signal for the controller to properly process the first and second signals.

34. The method of claim 27, wherein the step of generating said stopping signal when said exoskeleton is in said standing state includes generating a third signal followed by generating at least a fourth signal confirming the intention, where there is a sufficient amount of time between said third signal and said fourth signal for the controller to properly process the third and fourth signals.

35. The method of claim 27, wherein the step of generating at least one of the first and second walking signals or the first and second stopping signals comprises manipulating one or more user control elements selected from the group consisting of: a pushbutton, a switch, a thumb wheel, a thumb ball, a roll wheel, a track ball, a key, a knob, a linear variable differential transformer and a potentiometer.

36. The method of claim 27, wherein, when the exoskeleton is caused to move from said standing state to said walking state, said exoskeleton passes through a standing up state, the method further comprising:
generating a signal during said standing up state to cause the controller to return the exoskeleton to said seated state.

37. The method of claim 27, wherein, when the exoskeleton is caused to move from said standing state to said seated state, said exoskeleton passes through a sitting down state, the method further comprising:
generating a signal during the sitting down state to cause the controller to return the exoskeleton to said standing state.

38. The method of claim 27, wherein a user control element of the signal generator is utilized to generate only said first and second walking signals.

39. The method of claim 27, wherein a user control element of the signal generator is utilized to generate only said first and second stopping signal.

40. The method of claim 27, wherein a user control element of the signal generator is utilized to generate only said first and second walking signals and said first and second stopping signals.

41. A method of utilizing an orthesis system including an exoskeleton and a brain signal recognition system for generating user command signals based on the user's brain signals, the exoskeleton including a controller for shifting the exoskeleton between a seated state, a standing state, and a walking state based on the user command signals, the method comprising:
generating a first main signal when said exoskeleton is in said seated state to cause said exoskeleton to move from said seated state to said standing state;
generating a walking signal when said exoskeleton is in said standing state to cause said exoskeleton to move from said standing state to said walking state;
generating a stopping signal when said exoskeleton is in said walking state to cause said exoskeleton to move from said walking state to said standing state; and
generating a second main signal when said exoskeleton is in said standing state to cause said exoskeleton to move from said standing state to said seated state.

42. An orthesis system comprising:
an exoskeleton configured to be coupled to a user, said exoskeleton comprising:
first and second leg supports configured to be coupled to a user's lower limbs, each of the first and second leg supports including a thigh link;
an exoskeleton trunk configured to be coupled to a user's upper body, said exoskeleton trunk being rotatably connected to each of the first and second leg supports to allow for the flexion and extension between said first and second leg supports and said exoskeleton trunk;
first and second actuators coupled to respective first and second leg supports, said first and second actuators configured to provide movement of the exoskeleton;
an exoskeleton controller configured to shift said exoskeleton between a plurality of operational states and receive user command signals; and
a brain signal recognition system configured to generate and send a user command signal to said exoskeleton controller, wherein said user command signal causes said exoskeleton controller to shift said exoskeleton between a first operational state and a second operational state.

43. A method of utilizing an orthesis system including an exoskeleton and a voice signal recognition system for generating user command signals based on the user's auditory signals and the exoskeleton including a controller for shifting the exoskeleton between a seated state, a standing state, and a walking state based on the user command signals, the method comprising:
generating a first main signal when said exoskeleton is in said seated state to cause said exoskeleton to move from said seated state to said standing state;
generating a walking signal when said exoskeleton is in said standing state to cause said exoskeleton to move from said standing state to said walking state;
generating a stopping signal when said exoskeleton is in said walking state to cause said exoskeleton to move from said walking state to said standing state; and
generating a second main signal when said exoskeleton is in said standing state to cause said exoskeleton to move from said standing state to said seated state.
